(19) United States
(12) Patent Application Publication
(10) Pub. No.: US 2016/0202469 A1
(43) Pub. Date: Jul. 14, 2016

(54) SHUTTER-BASED LIGHT MODULATORS INCORPORATING LIGHT SPREADING STRUCTURES

(71) Applicant: Pixtronix, Inc., San Diego, CA (US)

(72) Inventor: Matthew Brian Sampsell, San Jose, CA (US)

(21) Appl. No.: 14/596,812

(22) Filed: Jan. 14, 2015

(51) Int. Cl. G02B 26/02; G09G 3/34

(52) U.S. Cl. CPC G02B 26/02; G09G 3/3433; G09G 2320/0233; G09G 2300/0473

(57) ABSTRACT

This disclosure provides systems, methods and apparatus for a MEMS display apparatus incorporating light spreading elements. The display apparatus can include display elements formed over, and in electrical communication with a backplane. The backplane can include one or more light blocking layers isolated by one or more dielectric layers. Light used for forming an image can pass through the various layers of the backplane. One or more of the dielectric layers of the backplane can include light spreading elements for spreading the light emitted by the display apparatus. The light spreading elements can provide a wide angular light distribution of light emitted by the display apparatus and improve a viewing angle associated with the display apparatus. In some implementations, the light spreading elements can include hemispheric, cylindrical, prismatic, diffraction grating, and/or diffusive light spreading elements.

### TECHNICAL FIELD

This disclosure relates to the field of displays, and in particular, electromechanical systems (EMS) display elements.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

EMS-based display apparatus have been proposed that include display elements that modulate light by selectively moving a light blocking component into and out of an optical path through an aperture defined through a light blocking layer. Doing so selectively passes light from a backlight or reflects light from the ambient or a front light to form an image.

### SUMMARY

The systems, methods and devices of the disclosure each have several innovative aspects, no single one of which is solely responsible for the desirable attributes disclosed herein.

One innovative aspect of the subject matter described in this disclosure can be implemented in an apparatus. The apparatus includes a substrate, a first light blocking layer oriented parallel to the substrate and defining a first set of optical windows. The apparatus further includes a first dielectric layer positioned over the first light blocking layer, and a second light blocking layer positioned over the first dielectric layer. The apparatus also includes a second dielectric layer positioned over the second light blocking layer. The apparatus further includes light spreading elements disposed in at least one of the first dielectric layer and the second dielectric layer. The light spreading elements are aligned with the first set of optical windows, and a light modulator positioned adjacent the light spreading elements.

In some implementations, the apparatus further includes a collimated backlight capable of emitting collimated light towards the light spreading elements. In some implementations, the second light blocking layer defines a second set of optical windows substantially aligned with the first set of optical windows. In some implementations, a longitudinal axis of the light spreading elements is substantially parallel to a long axis of an optical window defined in the first dielectric layer. In some implementations, the first light blocking layer and the second light blocking layer each include a metal. In some implementations, one of the first dielectric layer and the second dielectric layer includes photodefineable polycarbonate. In some implementations, the apparatus further includes a third light blocking layer positioned over the second dielectric layer and defining a third set of optical windows substantially aligned with the first set of optical windows. In some implementations, the apparatus further includes a third dielectric layer positioned adjacent to one of the first dielectric layer and the second dielectric layer, a boundary of which forms at least a portion of a boundary of the light spreading elements.

In some implementations, the apparatus further includes an output optical window defined in a light blocking layer, the output optical window being a narrowest optical window of all optical windows defined in the light blocking layers of the apparatus, and where the light spreading elements are formed in a dielectric layer positioned in front of the output optical window with respect to the backlight. In some implementations, one of the first dielectric layer and the second dielectric layer in which the light spreading elements are disposed has a thickness of at least 1 μm. In some implementations, at least two of a length, width and height of the light spreading elements are at least 1 μm. In some implementations, the light spreading elements include a fluid substantially enclosed by the first dielectric layer and the second dielectric layer. In some implementations, the fluid is the same as a fluid used for surrounding the light modulator. In some implementations, the fluid is different from a fluid used for surrounding the light modulator. In some implementations, the apparatus includes a backplane including the first light blocking layer, the first dielectric layer, the second light blocking layer, the second dielectric layer, and the light spreading elements, and where the light modulator is in electrical communication with the backplane.

In some implementations, apparatus further includes a display, a processor capable of communicating with the display, the processor being capable of processing image data, and a memory device capable of communicating with the processor. In some implementations, apparatus further includes a driver circuit capable of sending at least one signal to the display, and where the processor is further capable of sending at least a portion of the image data to the driver circuit. In some implementations, the apparatus further includes an image source module capable of sending the image data to the processor, where the image source module includes at least one of a receiver, transceiver, and transmitter. In some implementations, the apparatus further includes an input device capable of receiving input data and to communicate the input data to the processor.

Another innovative aspect of the subject matter described in this disclosure can be implemented in a method of manufacturing a display apparatus. The method includes depositing a first light blocking layer over a substrate and defining a first set of optical windows in the first light blocking layer. The method further includes depositing a first dielectric layer over the first light blocking layer. The method also includes depositing a second light blocking layer over the first dielectric layer and depositing a second dielectric layer over the second light blocking layer. The method additionally includes patterning one of the first dielectric layer and the second dielectric layer to form light spreading elements. The method also includes forming a plurality of display elements positioned adjacent the light spreading elements.

In some implementations, the method further includes patterning the second light blocking layer to define a second set of optical windows substantially aligned with the first set of optical windows. In some implementations, the plurality of display elements includes a plurality of light modulators positioned to modulate light emitted from a backlight and directed to the light spreading elements. In some implementations, patterning one of the first dielectric layer and the second dielectric layer to form light spreading elements includes aligning a longitudinal axis of the light spreading elements substantially parallel to a long axis of the first set of optical windows. In some implementations, patterning one of the first dielectric layers and the second dielectric layer to form light spreading elements includes forming the light spreading elements with at least two of the height, length, and width of the light spreading elements being at least 1 μm.

In some implementations, forming a plurality of display elements positioned adjacent the light spreading elements includes forming the plurality of display elements in electrical communication with at least one of the first light blocking layer and the second light blocking layer. In some implementations, the method further includes patterning the first dielectric layer exposed by the second set of optical windows to form a depression, depositing a third dielectric layer over the patterned first dielectric layer, depositing the second dielectric layer over the third dielectric layer, where patterning one of the first dielectric layer and the second dielectric layer to form the light spreading element includes patterning the second dielectric layer to define holes in the second dielectric layer and removing the third dielectric layer through the holes. In some such implementations, the method further includes depositing a fourth dielectric layer to plug the holes defined in the second dielectric layer.

In some implementations, the method further includes depositing a third light blocking layer over the second dielectric layer and defining a set of output optical windows in the third light blocking layer substantially aligned with the light spreading elements and where the set of output optical windows are narrower than the first set of optical windows. In some implementations, depositing a second dielectric layer over the second light blocking layer includes planarizing the second dielectric layer with a thickness of at least 1 μm.

Another innovative aspect of the subject matter described in this disclosure can be implemented in an apparatus including a substrate and a first light-blocking layer oriented parallel to the substrate and defining a first set of optical windows. The apparatus further includes a first dielectric layer positioned over the first light blocking layer, and a second light blocking layer positioned over the first dielectric layer. The apparatus also includes a second dielectric layer positioned over the second light blocking layer. The apparatus additionally includes light spreading means for spreading light incident from a rear side of the apparatus towards a front side of the apparatus. The light spreading means are disposed in at least one of the first dielectric layer and the second dielectric layer and are aligned with the first set of optical windows. The apparatus also includes a light modulator positioned adjacent the light spreading means.

In some implementations, the second light blocking layer defines a second set of optical windows substantially aligned with the first set of optical windows. In some implementations, apparatus further includes a collimated backlight capable of emitting collimated light towards the light spreading means. In some implementations, a longitudinal axis of the light spreading means is substantially parallel to a long axis of an optical window defined in one of the first dielectric layer and the second dielectric layer in which the light spreading means are disposed.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1A shows a schematic diagram of an example direct-view microelectromechanical systems (MEMS) based display apparatus.

FIG. 1B shows a block diagram of an example host device.

FIGS. 2A and 2B show views of an example dual actuator shutter assembly.

FIGS. 3-6 show cross-sectional views of various example shutter-based display apparatuses including light spreading elements.

FIGS. 7A-7E shows top views of various example light spreading elements that can be utilized in a display apparatus.

FIG. 8 shows a flow diagram of an example process for forming a display apparatus.

FIGS. 9A-9C show cross-sectional views of additional examples of shutter-based display apparatuses including light spreading elements.

FIGS. 10 and 11 show system block diagrams of an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that is capable of displaying an image, whether in motion (such as video) or stationary (such as still images), and whether textual, graphical or pictorial. The concepts and examples provided in this disclosure may be applicable to a variety of displays, such as liquid crystal displays (LCDs), organic light-emitting diode (OLED) displays, field emission displays, and electromechanical systems (EMS) and microelectromechanical (MEMS)-based displays, in addition to displays incorporating features from one or more display technologies.

The described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, wearable devices, clocks, calculators, television monitors, flat panel displays, electronic reading devices (such as e-readers), computer monitors, auto displays (such as odometer and speedometer displays), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, in addition to non-EMS applications), aesthetic structures (such as display of images on a piece of jewelry or clothing) and a variety of EMS devices.

A display apparatus can include display elements formed over, and in electrical communication with, a backplane. The backplane can include one or more light blocking layers isolated by one or more dielectric layers. Light used for forming an image can pass through the various layers of the backplane. In some implementations, one or more of the dielectric layers of the backplane can include light spreading elements for spreading the light emitted by the display apparatus. The light spreading elements can provide a wide angular light distribution of light emitted by the display apparatus. In some implementations, the light spreading elements can include hemispheric, cylindrical, prismatic, diffraction grating, and/or diffusive light spreading elements. In some implementations, the light spreading elements can be formed on an outer dielectric layer within the backplane. In some implementations, the light spreading elements can be formed on an inner dielectric layer within the backplane. In some implementations, the light spreading elements can be formed with a cavity defined by two adjacent dielectric layers. In some implementations, the cavity can be filled with fluid, where the fluid can be the same as the fluid used to surround a light modulator.

Particular implementations of the subject matter described in this disclosure can be implemented to realize one or more of the following potential advantages. By including light spreading elements formed within a backplane of a display apparatus, a wide viewing angle for the display apparatus can be provided without increasing the overall thickness of the display apparatus. Furthermore, the light spreading elements can work in concert with a collimated backlight to improve efficiency along with the view angle. The light spreading elements also can improve the light output of the display apparatus.

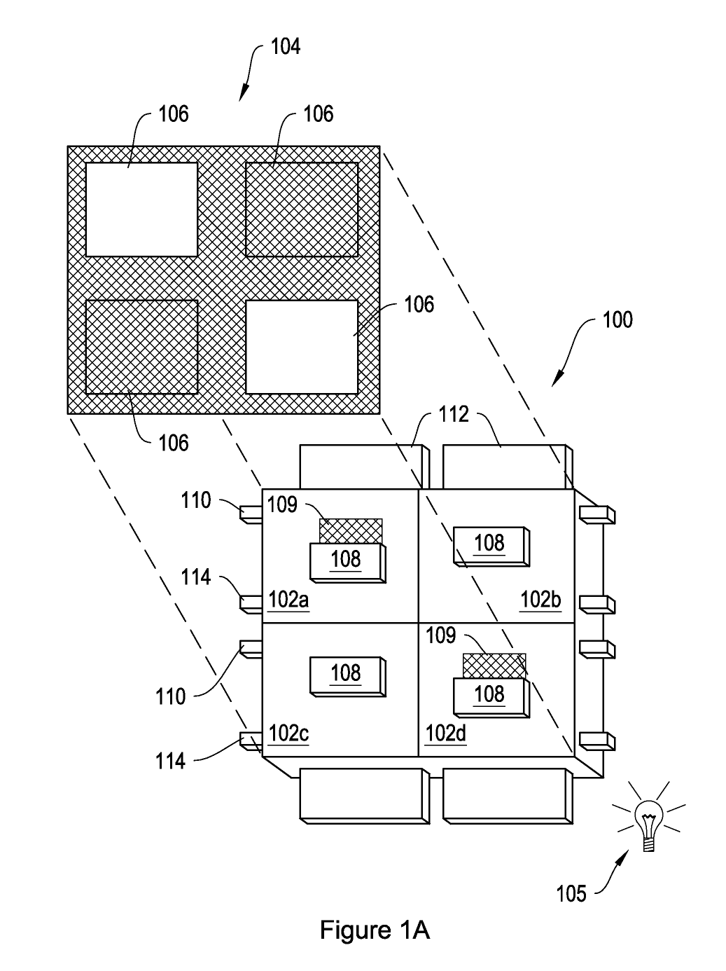

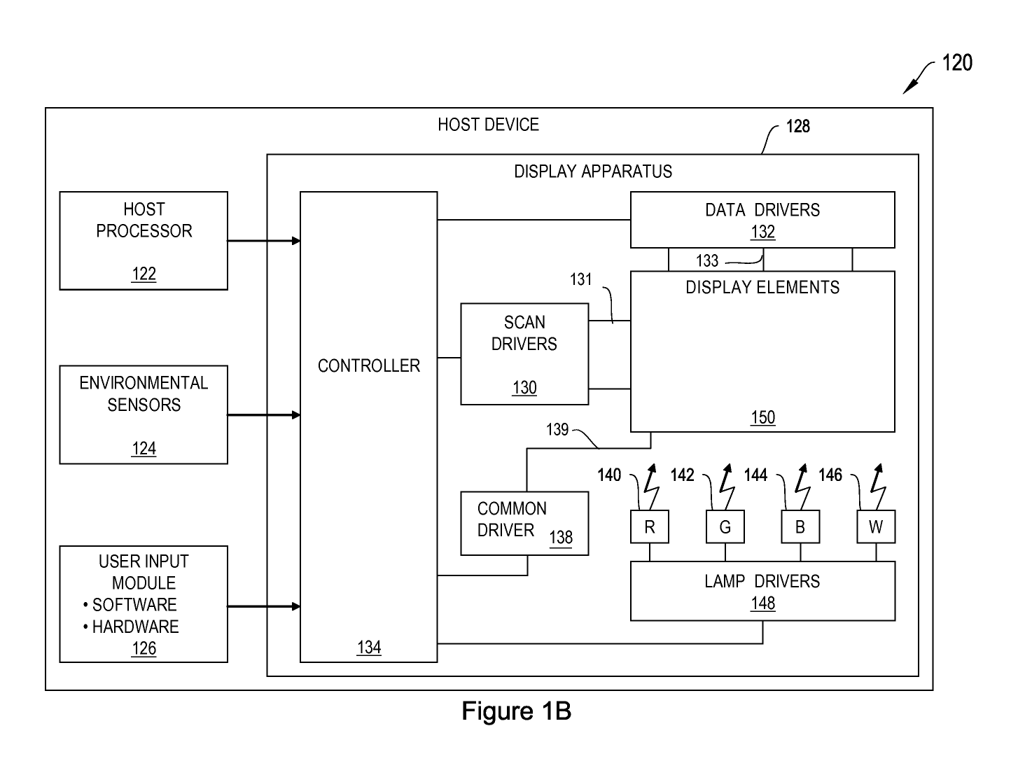

FIG. 1A shows a schematic diagram of an example direct-view MEMS-based display apparatus 100. The display apparatus 100 includes a plurality of light modulators 102a-102d (generally light modulators 102) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide a luminance level in an image 104. With respect to an image, a pixel corresponds to the smallest picture element defined by the resolution of image. With respect to structural components of the display apparatus 100, the term pixel refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the image can be seen by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or backlight so that each pixel can be uniformly illuminated. Transmissive direct-view displays are often built onto transparent substrates to facilitate a sandwich assembly arrangement where one substrate, containing the light modulators, is positioned over the backlight. In some implementations, the transparent substrate can be a glass substrate (sometimes referred to as a glass plate or panel), or a plastic substrate. The glass substrate may be or include, for example, a borosilicate glass, wine glass, fused silica, a soda lime glass, quartz, artificial quartz, Pyrex, or other suitable glass material.

Each light modulator 102 can include a shutter 108 and an aperture 109. To illuminate a pixel 106 in the image 104, the shutter 108 is positioned such that it allows light to pass through the aperture 109. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix coupled to the substrate and to the light modulators for controlling the movement of the shutters. The control matrix includes a series of electrical interconnects (such as interconnects 110, 112 and 114), including at least one write-enable interconnect 110 (also referred to as a scan line interconnect) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the write-enabling voltage, V_{WE}), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, such as transistors or other non-linear circuit elements that control the application of separate drive voltages, which are typically higher in magnitude than the data voltages, to the light modulators 102. The application of these drive voltages results in the electrostatic driven movement of the shutters 108.

The control matrix also may include, without limitation, circuitry, such as a transistor and a capacitor associated with each shutter assembly. In some implementations, the gate of each transistor can be electrically connected to a scan line interconnect. In some implementations, the source of each transistor can be electrically connected to a corresponding data interconnect. In some implementations, the drain of each transistor may be electrically connected in parallel to an electrode of a corresponding capacitor and to an electrode of a corresponding actuator. In some implementations, the other electrode of the capacitor and the actuator associated with each shutter assembly may be connected to a common or ground potential. In some other implementations, the transistor can be replaced with a semiconducting diode, or a metal-insulator-metal switching element.

FIG. 1B shows a block diagram of an example host device 120 (i.e., cell phone, smart phone, PDA, MP3 player, tablet, e-reader, netbook, notebook, watch, wearable device, laptop, television, or other electronic device). The host device 120 includes a display apparatus 128 (such as the display apparatus 100 shown in FIG. 1A), a host processor 122, environmental sensors 124, a user input module 126, and a power source.

The display apparatus 128 includes a plurality of scan drivers 130 (also referred to as write enabling voltage sources), a plurality of data drivers 132 (also referred to as data voltage sources), a controller 134, common drivers 138, lamps 140-146, lamp drivers 148 and an array of display elements 150, such as the light modulators 102 shown in FIG. 1A. The scan drivers 130 apply write enabling voltages to scan line interconnects 131. The data drivers 132 apply data voltages to the data interconnects 133.

In some implementations of the display apparatus, the data drivers 132 are capable of providing analog data voltages to the array of display elements 150, especially where the luminance level of the image is to be derived in analog fashion. In analog operation, the display elements are designed such that when a range of intermediate voltages is applied through the data interconnects 133, there results a range of intermediate illumination states or luminance levels in the resulting image. In some other implementations, the data drivers 132 are capable of applying a reduced set, such as 2, 3 or 4, of digital voltage levels to the data interconnects 133. In implementations in which the display elements are shutter-based light modulators, such as the light modulators 102 shown in FIG. 1A, these voltage levels are designed to set, in digital fashion, an open state, a closed state, or other discrete state to each of the shutters 108. In some implementations, the drivers are capable of switching between analog and digital modes.

The scan drivers 130 and the data drivers 132 are connected to a digital controller circuit 134 (also referred to as the controller 134). The controller 134 sends data to the data drivers 132 in a mostly serial fashion, organized in sequences, which in some implementations may be predetermined, grouped by rows and by image frames. The data drivers 132 can include series-to-parallel data converters, level-shifting, and for some applications digital-to-analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 139. In some other implementations, the common drivers 138, following commands from the controller 134, issue voltage pulses or signals to the array of display elements 150, for instance global actuation pulses which are capable of driving and/or initiating simultaneous actuation of all display elements in multiple rows and columns of the array.

Each of the drivers (such as scan drivers 130, data drivers 132 and common drivers 138) for different display functions can be time-synchronized by the controller 134. Timing commands from the controller 134 coordinate the illumination of red, green, blue and white lamps (140, 142, 144 and 146 respectively) via lamp drivers 148, the write-enabling and sequencing of specific rows within the array of display elements 150, the output of voltages from the data drivers 132, and the output of voltages that provide for display element actuation. In some implementations, the lamps are light emitting diodes (LEDs).

The controller 134 determines the sequencing or addressing scheme by which each of the display elements can be re-set to the illumination levels appropriate to a new image 104. New images 104 can be set at periodic intervals. For instance, for video displays, color images or frames of video are refreshed at frequencies ranging from 10 to 300 Hertz (Hz). In some implementations, the setting of an image frame to the array of display elements 150 is synchronized with the illumination of the lamps 140, 142, 144 and 146 such that alternate image frames are illuminated with an alternating series of colors, such as red, green, blue and white. The image frames for each respective color are referred to as color subframes. In this method, referred to as the field sequential color method, if the color subframes are alternated at frequencies in excess of 20 Hz, the human visual system (HVS) will average the alternating frame images into the perception of an image having a broad and continuous range of colors. In some other implementations, the lamps can employ primary colors other than red, green, blue and white. In some implementations, fewer than four, or more than four lamps with primary colors can be employed in the display apparatus 128.

In some implementations, where the display apparatus 128 is designed for the digital switching of shutters, such as the shutters 108 shown in FIG. 1A, between open and closed states, the controller 134 forms an image by the method of time division gray scale. In some other implementations, the display apparatus 128 can provide gray scale through the use of multiple display elements per pixel.

In some implementations, the data for an image state is loaded by the controller 134 to the array of display elements 150 by a sequential addressing of individual rows, also referred to as scan lines. For each row or scan line in the sequence, the scan driver 130 applies a write-enable voltage to the write enable interconnect 131 for that row of the array of display elements 150, and subsequently the data driver 132 supplies data voltages, corresponding to desired shutter states, for each column in the selected row of the array. This addressing process can repeat until data has been loaded for all rows in the array of display elements 150. In some implementations, the sequence of selected rows for data loading is linear, proceeding from top to bottom in the array of display elements 150. In some other implementations, the sequence of selected rows is pseudo-randomized, in order to mitigate potential visual artifacts. And in some other implementations, the sequencing is organized by blocks, where, for a block, the data for a certain fraction of the image is loaded to the array of display elements 150. For example, the sequence can be implemented to address every fifth row of the array of the display elements 150 in sequence.

In some implementations, the addressing process for loading image data to the array of display elements 150 is separated in time from the process of actuating the display elements. In such an implementation, the array of display elements 150 may include data memory elements for each display element, and the control matrix may include a global actuation interconnect for carrying trigger signals, from the common driver 138, to initiate simultaneous actuation of the display elements according to data stored in the memory elements.

In some implementations, the array of display elements 150 and the control matrix that controls the display elements may be arranged in configurations other than rectangular rows and columns. For example, the display elements can be arranged in hexagonal arrays or curvilinear rows and columns.

The host processor 122 generally controls the operations of the host device 120. For example, the host processor 122 may be a general or special purpose processor for controlling a portable electronic device. With respect to the display apparatus 128, included within the host device 120, the host processor 122 outputs image data as well as additional data about the host device 120. Such information may include data from environmental sensors 124, such as ambient light or temperature; information about the host device 120, including, for example, an operating mode of the host or the amount of power remaining in the host device's power source; information about the content of the image data; information about the type of image data; and/or instructions for the display apparatus 128 for use in selecting an imaging mode.

In some implementations, the user input module 126 enables the conveyance of personal preferences of a user to the controller 134, either directly, or via the host processor 122. In some implementations, the user input module 126 is controlled by software in which a user inputs personal preferences, for example, color, contrast, power, brightness, content, and other display settings and parameters preferences. In some other implementations, the user input module 126 is controlled by hardware in which a user inputs personal preferences. In some implementations, the user may input these preferences via voice commands, one or more buttons, switches or dials, or with touch-capability. The plurality of data inputs to the controller 134 direct the controller to provide data to the various drivers 130, 132, 138 and 148 which correspond to optimal imaging characteristics.

The environmental sensor module 124 also can be included as part of the host device 120. The environmental sensor module 124 can be capable of receiving data about the ambient environment, such as temperature and or ambient lighting conditions. The sensor module 124 can be programmed, for example, to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

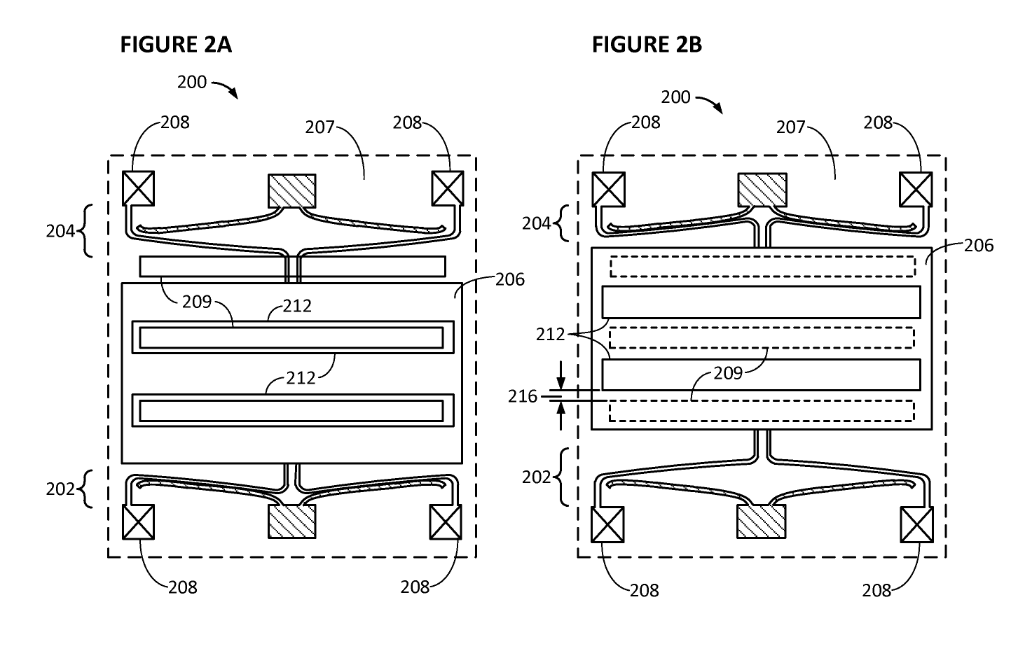

FIGS. 2A and 2B show views of an example dual actuator shutter assembly 200. The dual actuator shutter assembly 200, as depicted in FIG. 2A, is in an open state. FIG. 2B shows the dual actuator shutter assembly 200 in a closed state. The shutter assembly 200 includes actuators 202 and 204 on either side of a shutter 206. Each actuator 202 and 204 is independently controlled. A first actuator, a shutter-open actuator 202, serves to open the shutter 206. A second opposing actuator, the shutter-close actuator 204, serves to close the shutter 206. Each of the actuators 202 and 204 can be implemented as compliant beam electrode actuators. The actuators 202 and 204 open and close the shutter 206 by driving the shutter 206 substantially in a plane parallel to an aperture layer 207 over which the shutter is suspended. The shutter 206 is suspended a short distance over the aperture layer 207 by anchors 208 attached to the actuators 202 and 204. Having the actuators 202 and 204 attach to opposing ends of the shutter 206 along its axis of movement reduces out of plane motion of the shutter 206 and confines the motion substantially to a plane parallel to the substrate (not depicted).

In the depicted implementation, the shutter 206 includes two shutter apertures 212 through which light can pass. The aperture layer 207 includes a set of three apertures 209. In FIG. 2A, the shutter assembly 200 is in the open state and, as such, the shutter-open actuator 202 has been actuated, the shutter-close actuator 204 is in its relaxed position, and the centerlines of the shutter apertures 212 coincide with the centerlines of two of the aperture layer apertures 209. In FIG. 2B, the shutter assembly 200 has been moved to the closed state and, as such, the shutter-open actuator 202 is in its relaxed position, the shutter-close actuator 204 has been actuated, and the light blocking portions of the shutter 206 are now in position to block transmission of light through the apertures 209 (depicted as dotted lines).

Each aperture has at least one edge around its periphery. For example, the rectangular apertures 209 have four edges. In some implementations, in which circular, elliptical, oval, or other curved apertures are formed in the aperture layer 207, each aperture may have a single edge. In some other implementations, the apertures need not be separated or disjointed in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through the apertures 212 and 209 in the open state, the width or size of the shutter apertures 212 can be designed to be larger than a corresponding width or size of apertures 209 in the aperture layer 207. In order to effectively block light from escaping in the closed state, the light blocking portions of the shutter 206 can be designed to overlap the edges of the apertures 209. FIG. 2B shows an overlap 216, which in some implementations can be predefined, between the edge of light blocking portions in the shutter 206 and one edge of the aperture 209 formed in the aperture layer 207.

The electrostatic actuators 202 and 204 are designed so that their voltage-displacement behavior provides a bi-stable characteristic to the shutter assembly 200. For each of the shutter-open and shutter-close actuators, there exists a range of voltages below the actuation voltage, which if applied while that actuator is in the closed state (with the shutter being either open or closed), will hold the actuator closed and the shutter in position, even after a drive voltage is applied to the opposing actuator. The minimum voltage needed to maintain a shutter's position against such an opposing force is referred to as a maintenance voltage Vₘ.

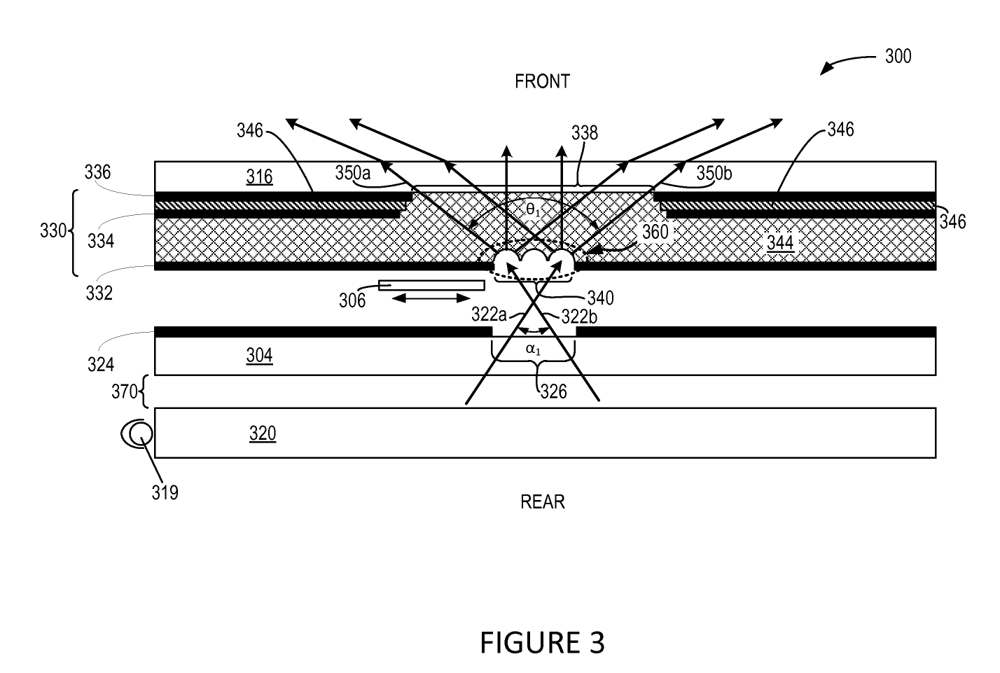

FIG. 3 shows a cross-sectional view of an example shutter-based display apparatus 300 including light spreading elements. The display apparatus 300 includes a shutter 306 suspended between a front substrate 316 and a rear substrate 304. The shutter 306 is shown in an open position in FIG. 3. A rear aperture layer 324 is positioned on the front-facing surface of the rear substrate 304. The rear aperture layer 324 defines a rear aperture 326. A backplane 330 is positioned on the rear-facing side of the front substrate 316. The backplane 330 includes an M1 metal layer 336, an M2 metal layer 334, and an M3 metal layer 332. A second dielectric layer 344 separates the M3 metal layer 332 from the M2 metal layer 334. A first dielectric layer 346 separates the M2 metal layer 334 from the M1 metal layer 336. A person having ordinary skill in the art will readily understand that the first dielectric layer 346 may include one or more layers, having different indices of refraction. Similarly, the second dielectric layer 344 also may include one or more layers, having different indices of refraction. In some implementations, the backplane 330 also can include the substrate 316 in addition to the M1 metal layer 336, the M2 metal layer 334, the M3 metal layer 332, the first dielectric layer 346 and the second dielectric layer 344. In some implementations, the backplane 330 can further include circuitry (not shown) formed over the metal or dielectric layers.

In some implementations, the M1 metal layer 336, the M2 metal layer 334, the M3 metal layer 332, can be patterned to provide both electrical and optical functionality. Specifically, in some implementations, the metal layers can be patterned to provide interconnects to carry signals between circuit components within the backplane or to form components of such circuit components. The metal layers also can be patterned to provide optical functionality by blocking a path of light directed towards the front of the display apparatus 300. For example, referring again to FIG. 3, the M1 metal layer 338 and the M3 metal layer 332 can be patterned to not only form interconnects, but also to form a first optical window 338 and a second optical window 340, respectively. The optical windows 338 and 340 allow light to pass by the metal layers at defined locations, while light incident on portions of the M1 metal layer 338 and the M3 metal layer 332 adjacent to the optical windows 338 and 340 from the rear of the display apparatus 300 is blocked. In some implementations, the optical windows can have a shape that is similar to the shape of the rear aperture 326. In some implementations, the optical windows can be patterned to have dimensions similar to those of the aperture 326. In some other implementations, the optical windows can have the same shape but larger dimensions compared to those of the aperture 326. In some implementations, the optical windows can affect an angular light distribution of the light emitted by the display apparatus 300 (discussed below). In some implementations, one or more metal layers, for example the M2 metal layer 334, can be patterned primarily to form interconnects and other electrical components, while providing negligible, if any, optical functionality, such as blocking a light path and/or affecting the angular distribution of light passing the metal layer.

In some implementations, it may be desirable to include thicker dielectric layers, in particular a thicker second dielectric layer 344, to reduce capacitance, cross-talk, and/or shorting between electrical components patterned into the M2 metal and M3 metal layers 334 and 332. Thicker dielectric layers, however, result in an overall thicker backplane. A thicker backplane may undesirably reduce a viewing angle of the display apparatus. For example, a thicker second dielectric layer 344 may increase the distance between the first optical window 338 and the second optical window 340. An increase in the distance between the first optical window 338 and the second optical window 340 may reduce the angle at which light is emitted out of the display apparatus and thus reduce the viewing angle of the display apparatus. As discussed below, the reduction in the viewing angle of the display apparatus due to thicker backplanes can be mitigated by employing light spreading elements that spread the light emitted by the display apparatus over wider angles.

The M1 metal layer 336 defines a first optical window 338. In some implementations the first optical window 338 may instead be defined by a dark dielectric layer (such as a carbon-doped spin-on-glass material such as silicates and siloxanes including, without limitation, hydrogen silsesquioxane (HSQ) and methylsilozane) deposited in place of, before, or after the M1 metal layer 336. The M3 metal layer defines a second optical window 340. The first optical window 338 and the second optical window 340 are aligned with the rear aperture 326 to define an optical path through which light can escape from the display apparatus 300 towards a viewer. A light source 319 and a light guide 320 (together forming a backlight) are positioned behind the rear substrate 304. The light guide 320 is separated from the rear substrate 304 by a gap 370. In some implementations, the gap 370 can be filled with air. In some other implementations, the gap 370 can be filled with another fluid or a vacuum. The fluid or vacuum filling the gap 370 can aid in extracting a desired angular distribution of light from the light guide 320.

The M3 metal layer 332, the M2 metal layer 334, and the M1 metal layer 336 can each be formed from metals. In some implementations, the metals may be selected to be substantially non-reflective, so that light impinging on the surfaces of the M3 metal layer 332, the M2 metal layer 334, and the M1 metal layer 336 is absorbed and blocked rather than reflected. Absorbing light can reduce the amount of ambient light or erroneously reflected light exiting the display apparatus 300. This can improve the performance of a display in which the display apparatus 300 is incorporated, for example, by increasing the contrast ratio of the display. In some implementations, the M3 metal layer 332 can be maintained at a common potential as the shutter 306 to prevent attraction between the shutter 306 and the backplane 330.

In some implementations, the shutter 306 of the display apparatus 300 can function in a manner similar to the shutter 206 of the light modulator 200 shown in FIGS. 2A and 2B. The shutter 306 can be moved laterally into open and closed positions, in response to actuation voltages. When the shutter 306 is in an open position, as shown in FIG. 3, the shutter 306 is positioned beside the optical path between the aperture 326 and the second optical window 340, allowing light to pass out of the display apparatus 300.

The second dielectric layer 344 includes light spreading elements 360 disposed near the second optical window 340. The light spreading elements 360 form an integral part of the second dielectric layer 344 and can be patterned into the second dielectric layer 344 during manufacture of the display apparatus 300. In some implementations, the light spreading elements 360 can be formed on substantially the entire rear facing area of the second dielectric layer 344 that can be exposed to the backlight through the second optical window 340.

The light spreading elements 360 spread light incident from the rear of the display apparatus 300 (i.e., from the backlight). Light rays, such as light rays 322a and 322b, incident on the second dielectric layer 344 through the second optical window 340 are spread towards the front of the display apparatus 300 by the light spreading elements 360. The light spreading elements 360 also can spread other light rays incident on the second dielectric layer 344 towards the front of the display apparatus at various angles and intensities. An angular light distribution of the incident light is represented by an angular light distribution angle α₁, between the light rays 322a and 322b. It should be noted that FIG. 3 shows the angular light distribution only in the plane of the cross-section through the shortest dimension of the first optical window 338 and the second optical window 340. A person skilled in the art will readily understand that light distribution angles may differ in other planes having orientations other than the one shown in FIG. 3. In other planes, the optical windows, such as the first and the second optical windows 338 and 340, as well as rear aperture 326, may have different dimensions than in FIG. 3. These different dimensions may allow or clip differing portions of light directed towards the front of the display apparatus 300, thereby resulting in different light distribution angles. For example, in a plane rotated 90° about the display normal, along the long axis of the optical windows 338 and 340 and rear aperture 326, a larger range of angles of light can pass through the display apparatus (allowing a larger light distribution angle).

In some implementations, the display apparatus 300 can be capable of having a wide viewing angle. In some implementations, the viewing angle of the display apparatus 300 can be a function of the angular light distribution of the display apparatus 300. A wider angular light distribution can result in a larger viewing angle. The width of the angular light distribution of the display apparatus 300 can be described in terms of a light distribution angle of the light emitted out of the first optical window 338. In the absence of the light spreading elements 360, the light distribution angle of the light emitted out of the first optical window 338 may be substantially the same as the light distribution angle α₁ of the incident light rays 322a and 322b. However, in the presence of the light spreading elements 360, the incident light can be spread and emitted out of the first optical window 338 with a substantially wider angular light distribution. Specifically, the light distribution angle of the light emitted out of the first optical window 338 is denoted by θ₁, which is greater than the light distribution angle α₁, as shown in FIG. 3. As discussed above, a person skilled in the art will readily understand that light distribution angles may differ in planes having orientations other than the one shown in FIG. 3. The light emitted out of the first optical window 338 is further spread when exiting the display apparatus 300 due to the difference in the refractive indices of the front substrate 316 and air.

In some implementations, a narrowest optical window within the backplane 330 can be denoted as an “output optical window,” as the width of the output optical window can determine the light distribution angle θ₁. For example, the second optical window 340 formed in the M3 metal layer 332, which is the narrowest optical window in the backplane 330, is the output optical window for the display apparatus 300. As shown in FIG. 3, the light spreading elements 360 are positioned in front of the output optical window such that the final output light distribution angle is not further narrowed after the light passes through the light spreading elements 360.

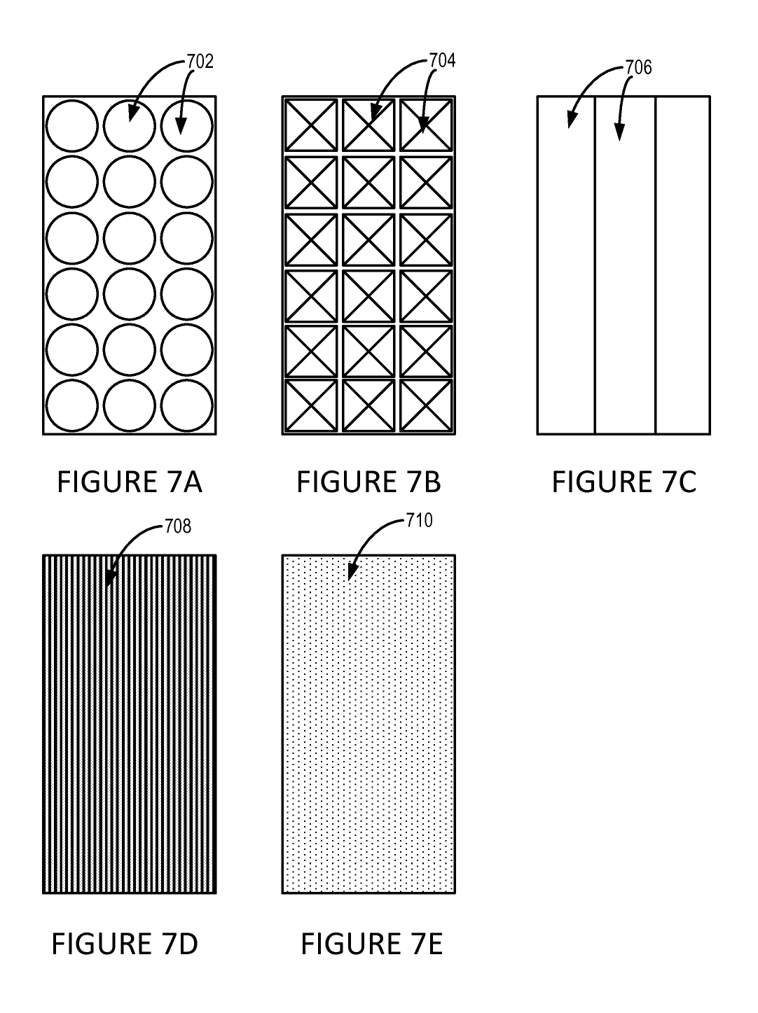

The sizes, shapes, and orientations of the light spreading elements can be selected based on the desired angular light distribution. Various types of light spreading elements are discussed further below in relation to FIGS. 7A-7E.

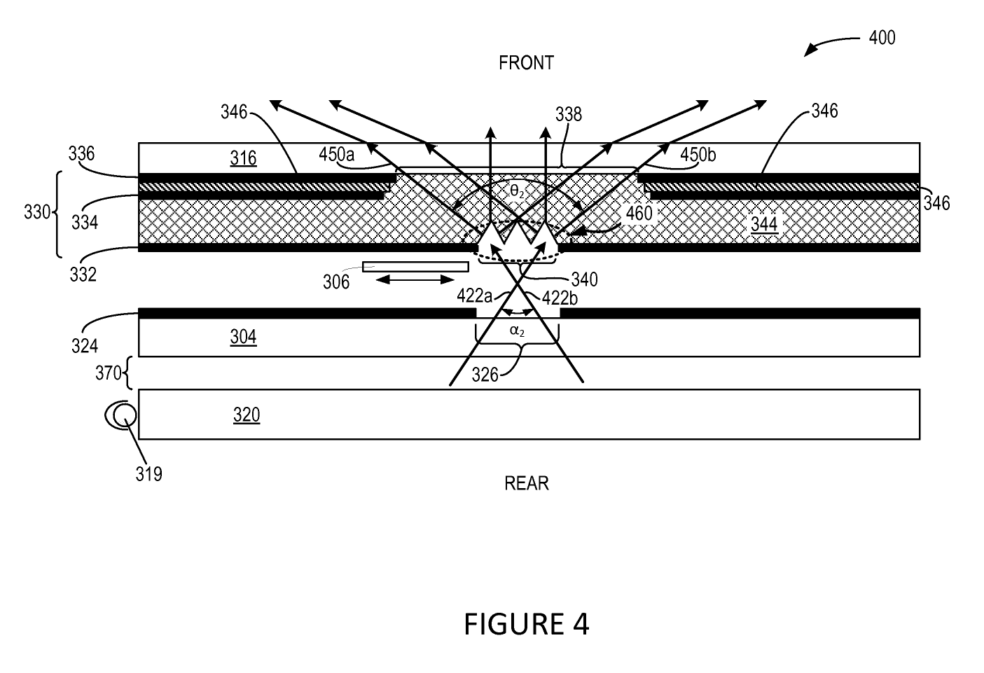

FIG. 4 shows a cross-sectional view of another example shutter-based display apparatus 400 including light spreading elements 460. In particular, FIG. 4 shows the cross-sectional view of the second dielectric layer 344 having prismatic light spreading elements 460. The prismatic light spreading elements 460 can be similar to the light spreading elements 360 discussed above in relation to FIG. 3. The light spreading elements 360 and the prismatic light spreading elements 460 spread light incident from the backlight to the front of the display apparatus 400. For example, light rays 422a and 422b incident with an angle α₂, can be spread by the prismatic light spreading elements 460 as light rays 450a and 450b with a substantially larger light distribution angle θ₂ towards the front of the display apparatus 400. In some implementations, the shape of the prismatic light spreading elements 460 can be designed to provide an angular light distribution that is different from that provided by the light spreading elements 360. For example, the light distribution angle θ₂ can be different from the light distribution angle θ₁ provided by the light spreading elements 360 shown in FIG. 3. Similar to the display apparatus 300 shown in FIG. 3, the second optical window 340 formed in the M3 metal layer 332 can serve as the output optical window of the display apparatus 400, and the light spreading elements 460 can be positioned in front of that output optical window.

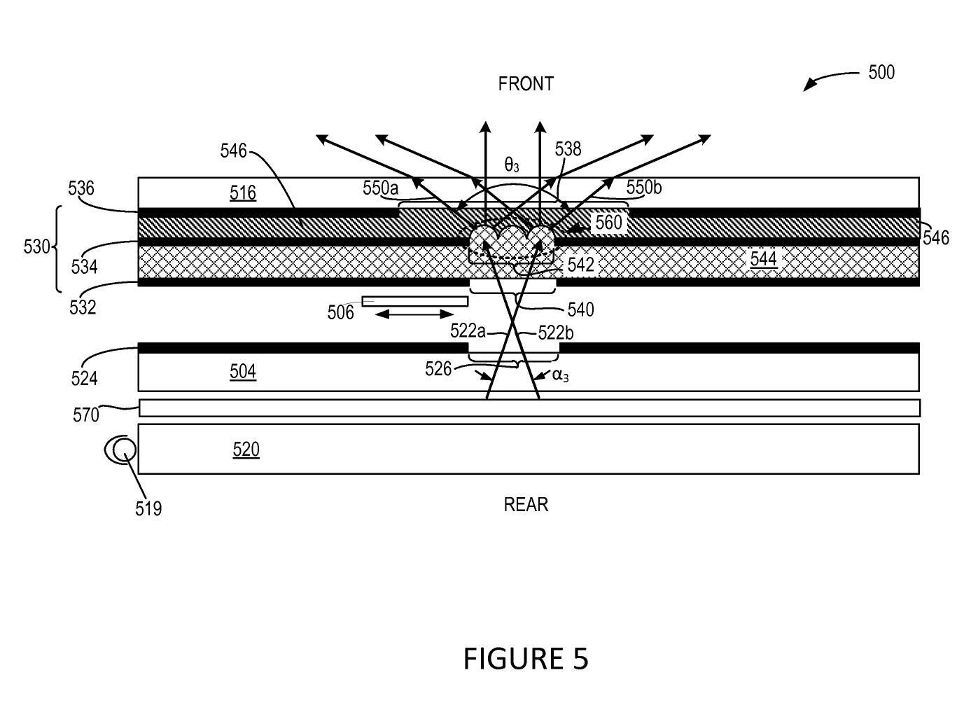

FIG. 5 shows a cross-sectional view of another example shutter based display apparatus 500 including light spreading elements 560. In particular, FIG. 5 shows the light spreading elements 560 formed at an interface of two dielectric layers. The display apparatus 500 includes many of the components of the display apparatus 300 shown in FIG. 3. For example, the display apparatus 500 includes a shutter 506 suspended between a front substrate 516 and a rear substrate 504. A rear aperture layer 524 is positioned on the front-facing surface of the rear substrate 504. The rear aperture layer 524 defines a rear aperture 526. A backplane 530 is positioned on the rear-facing side of the front substrate 516. The backplane 530 includes three metal layers: an M3 metal layer 532, an M2 metal layer 534, and an M1 metal layer 536. A second dielectric layer 544 separates the M3 metal layer 532 from the M2 metal layer 534. A first dielectric layer 546 separates the M2 metal layer 534 from the M1 metal layer 536. The M3 metal layer 532, M2 metal layer 534, and M1 metal layer 536 of the backplane 530 define a second optical window 540, a third optical window 542, and a first optical window 538, respectively. In some implementations, the M2 metal layer 534 can be patterned primarily to form interconnects connecting various electrical components within the backplane 530 or to form portions of other electrical components, such as transistors terminals or capacitor electrodes, while providing negligible, if any, optical functionality. For example, the M2 metal layer 534 can be patterned such that the M2 metal layer 534 is removed from the vicinity of the light spreading elements 560 and from the path of the light passing to and from the light spreading elements 560.

The display apparatus 500 further includes brightness enhancing film (BEF) 570 positioned proximate to the front-facing surface of a light guide 520, which in combination with a light source 519 form a backlight. In some implementations, such as the ones in which air is used as the fluid between the front substrate 516 and the rear substrate 504 to surround the shutters 506, the relative refractive indices of air and the rear substrate 504, and of air and the second dielectric layer 544 may cause a portion of the light passing out of the rear aperture 526 to be refracted within the display apparatus instead of being directed out of the display apparatus and towards the viewer. The light refracted within the display apparatus may be absorbed by various internal surfaces, such as the light absorbing layers and aperture layers, resulting in poor efficiency and contrast ratio of the display apparatus. In some such implementations, the BEF 570 can aid in directing the light emitted by the backlight appropriately (such as collimating light with a narrower light distribution angle) towards the front of the display apparatus 500 to reduce the amount of light absorbed within the display apparatus and improve the efficiency and contrast ratio. The BEF 570 can include a stack of films such as, without limitations, reflective films, diffusion films, and prismatic films. The BEF 570 can improve the light output of the backlight and also emit light with a relatively narrow angle. In some implementations, the light guide 520 also can include a front facing reflective surface or a reflective film to provide light recycling. In some implementations, the BEF 570 can include cross-BEFs (XBEFs), that is, at least two prismatic films arranged such that their respective prism axes are non-parallel (or in some implementations, orthogonal). In some implementations, the front facing surface of the light guide 520 or the BEF 570 can include lenses for further collimating and directing light towards the front of the display apparatus 500 at a narrow angle of incidence. The BEF 570 also can be incorporated into the display apparatus 300 and 400 shown in FIGS. 3 and 4, respectively. A person skilled in the art will readily understand that any backlight design that directs the light emitted by the backlight appropriately (such as collimating light with a narrower light distribution angle) towards the front of the display apparatus 500 will reduce the amount of light absorbed within the display apparatus and improve the efficiency and contrast ratio.

The display apparatus 500, unlike the display apparatus 300 shown in FIG. 3, includes the first dielectric layer 546 covering the first optical window 538. The first dielectric layer 546 includes light spreading elements 560 disposed near the third optical window 542. Unlike the light spreading elements 360 shown in FIG. 3, which were formed in the second dielectric layer 344 of the display apparatus 300, the light spreading elements 560 form an integral part of the first dielectric layer 546, and can be patterned into the first dielectric layer 546 during manufacture of the display apparatus 500. In some implementations, the light spreading elements 560 can be formed on substantially the entire rear facing area of the first dielectric layer 546 that can be exposed to the backlight through the second optical window 540.

The light spreading elements 560 spread light incident from the rear of the display apparatus 500 (i.e., from the collimating lenses 570). Light rays 522a and 522b pass through the second optical window 540 and the second dielectric layer 544 before being incident on the light spreading elements 560 in the first dielectric layer 546 at an angle α₃. The light spreading elements 560 spread the incident light towards the front of the display apparatus 500 at various angles and intensities. For example, the light spreading elements 560 spread the light rays 550a and 550b towards the front of the display apparatus 500 at a light distribution angle denoted by θ₃, which can be greater than the angle α₃ of the incident light rays 522a and 522b on the rear of the light spreading elements 560.

In some implementations, the relative refractive indices of the materials at the boundaries of the light spreading elements can affect the light distribution angle of the light spreading elements. For example, in the display apparatuses 300 and 400 shown in FIGS. 3 and 4 respectively, the light spreading elements 360 and 460 are formed in the second dielectric layers. Thus, the two materials at the boundaries of the light spreading elements 360 and 460 are the material used for forming the second dielectric layer 344 and the fluid (such as oil, air, or even in vacuum conditions, etc.) used to fill the gap between the M3 metal layer 332 and the aperture layer 324. The light distribution angles θ₁ and θ₂ can be a function, in part, of the relative refractive indices of the fluid and the second dielectric layer 344. On the other hand, in the display apparatus 500 shown in FIG. 5, the second dielectric layer 544 and the first dielectric layer 546 come in contact at the boundaries of the light spreading elements 560. Thus, the light distribution angle θ₃ can be a function, in part, of the relative refractive indices of the second dielectric layer 544 and the first dielectric layer 546. In some implementations, if oil is used as a fluid to fill the gap between the M3 metal layer 332 and the aperture layer 324 shown in FIG. 3, the second dielectric material 344 may be selected with a relatively higher refractive index than if air were used as the fluid. In some implementations, the refractive indices of the second dielectric layer 344 shown in FIGS. 3 and 4 and the second dielectric layer 544 shown in FIG. 5 can be between about 1.3 to about 2.1, for example, about 1.5, or even more particularly, about 1.57. Furthermore, the refractive indices of the first dielectric layer 346 in FIGS. 3 and 4, and of the first dielectric layer 546 in FIG. 5 may be chosen to be relatively lower, for example, between about 1.25 to about 2.05, or about 1.45. This refractive index may be lower than the refractive indices of the second dielectric layers 344 and 544, respectively, such as to create a large refractive index difference between the first and second dielectrics, thereby increasing the refractive power of the light spreading elements 360 and 560.

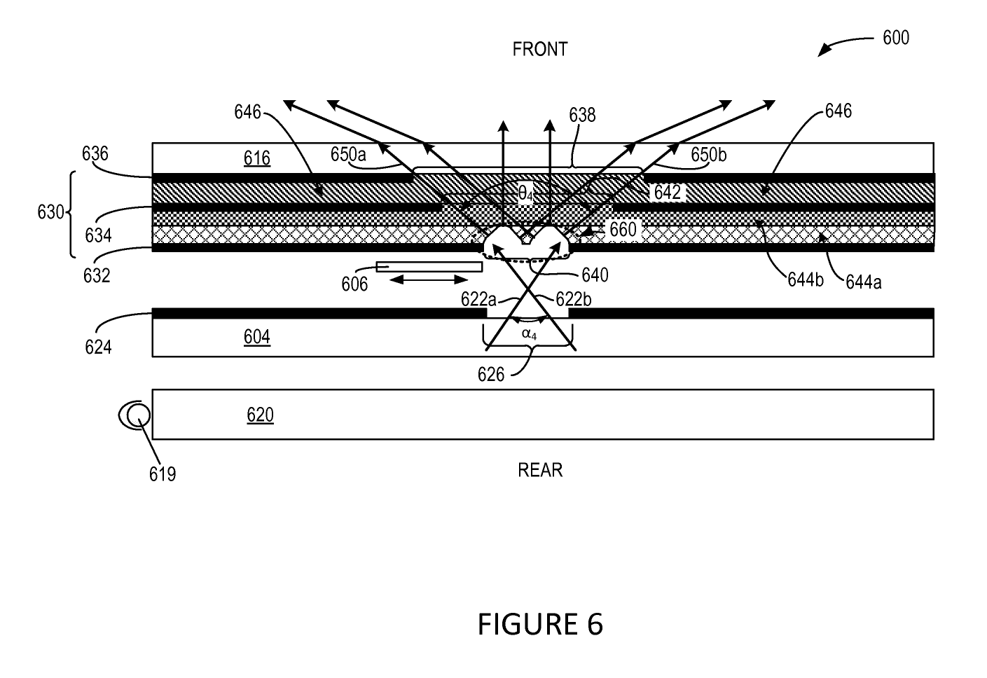

FIG. 6 shows a cross-sectional view of yet another example shutter-based display apparatus 600 including light spreading elements 660. In particular, the display apparatus 600 includes light spreading elements 660 that are formed within a dielectric layer by utilizing another adjacent dielectric layer as an etch stop. The display apparatus 600 includes a shutter 606 suspended between a front substrate 616 and a rear substrate 604. A rear aperture layer 624 is positioned on the front-facing surface of the rear substrate 604. The rear aperture layer 624 defines a rear aperture 626. A backplane 630 is positioned on the rear-facing side of the front substrate 616. The backplane 630 includes three metal layers: an M3 metal layer 632, an M2 metal layer 634, and an M1 metal layer 636. A first dielectric layer 646 separates the M2 metal layer 634 from the M1 metal layer 636. A combination of a second dielectric layer 644a and a third dielectric layer 644b separates the M3 metal layer 632 from the M2 metal layer 634. The M3 metal layer 632, M2 metal layer 634, and M1 metal layer 636 of the backplane 630 define a second optical window 640, a third optical window 642, and a first optical window 638, respectively. The display apparatus 600 also includes light guide 620 illuminated by a light source 619 (which in combination form a backlight). In some implementations, the M2 metal layer 634 can be patterned primarily to form interconnects connecting various electrical components within the backplane 630 or to form portions of such electrical components, while providing negligible, if any, optical functionality. For example, the M2 metal layer 634 can be patterned such that the M2 metal layer 634 is removed from the vicinity of the light spreading elements 660 and from the path of the light passing to and from the light spreading elements 660.

The display apparatus 600 also includes light spreading elements 660 formed in the second dielectric layer 644a. The light spreading elements 660 spread light in a manner similar to that described above in relation to light spreading elements 360, 460, and 560 shown in FIGS. 3, 4, and 5, respectively. That is, the light spreading elements 660 receive incident light, shown by light rays 622a and 622b, at an angle α₄ and emit light towards the front of the display apparatus 600, shown by light rays 650a and 650b, at a wider light distribution angle θ₄. The wider light distribution angle θ₄ can improve the viewing angle of the display apparatus 600.

The light spreading elements 660 can be formed within the second dielectric layer 644a. During manufacture, the second dielectric layer 644a is patterned and etched to form the light spreading elements 660. The third dielectric layer 644b is formed of a material that is relatively inert to the etching agents (such as, for example, etching chemicals, light, etc.) used for etching the second dielectric layer 644a. For example, if the second dielectric layer 644a is photodefineable to allow formation of the light spreading elements 660 by exposure to light, the third dielectric layer 644b can be formed of a material that is not photosensitive. As a result, during the etching of the second dielectric layer 644a, the cavities etched to form the light spreading elements 660 are stopped from extending beyond the boundary that separates the second and third dielectric layers 644a and 644b. That is, the third dielectric layer 644b acts as an etch-stop to the formation of the light spreading elements 660 formed in the second dielectric layer 644a. A portion of the boundary of the third dielectric layer 644b forms at least a portion of the light spreading elements 660. In some implementations, the thicknesses of the second and the third dielectric layers 644a and 644b can be selected to achieve the desired dimensions of the light spreading elements 660. In some implementations, the light spreading elements 660 can be formed simultaneously with forming vias within the backplane 630 that electrically connect one of the metal layers in the backplane 630 to other devices supported by the backplane 630. In some implementations, for example, when the vias are used for connecting the M3 metal layer 632 to the M2 metal layer 634, the formation of the vias may also discontinue at the boundary of the third dielectric layer 644b. In such instances, additional etching steps may be utilized for extending the vias through the third dielectric layer 644b to the M2 metal layer 634.

In some implementations, the display apparatus 600 may not include the third dielectric layer 644b and may instead utilize the first dielectric layer 646 as an etch-stop for the formation of the light spreading elements 660 in the second dielectric layer 644a. In some such implementations, the light spreading elements 660 can be formed simultaneously with forming vias within the backplane 630 that can electrically connect two or more metal layers, such as, the M3 metal layer 632 and the M2 metal layer 634. For example, while the first dielectric layer 646 serves as an etch stop for the light spreading elements formed in the second dielectric layer 644a, the M2 metal layer 634 can serve as an etch stop for the vias simultaneously being formed in the second dielectric layer 644a. At the end of the etching process, the second dielectric layer 646 can form a boundary for the light spreading elements 660 while the M2 metal layer 634 can form a boundary for the vias. Thus additional etching steps may not be needed for forming vias that connect the M3 metal layer 632 to the M2 metal layer 634. In some implementations, the technique of using an etch-stop dielectric layer also can be utilized to form light spreading elements in the first dielectric layer 646, or any other dielectric layer of the display apparatus 600.

In some implementations, the display apparatus shown in FIGS. 3-6 can include light spreading elements in more than one dielectric layer. For example, referring to FIG. 5, the display apparatus 500 can include light spreading elements in the second dielectric layer 544 in addition to the light spreading elements 560 in the first dielectric layer 546. In some implementations, the light spreading elements in the second dielectric layer 544 can be formed on substantially the entire rear facing area of the second dielectric layer 544 that can be exposed to the backlight through the second optical window 540. Similarly, referring to FIG. 6, light spreading elements can be included in the first dielectric layer 646 and/or the third dielectric layer in addition to the light spreading elements 660 formed within the second dielectric layer 644a.

FIGS. 7A-7E shows top views of various example light spreading elements that can be utilized in a display apparatus. In particular, the light spreading elements shown in FIGS. 7A-7E can be utilized for forming the light spreading elements 360, 460, 560 and 660 shown in FIGS. 3, 4, 5 and 6 respectively. FIG. 7A shows an array of hemispherical light spreading elements 702, FIG. 7B shows an array of prismatic light spreading elements 704, FIG. 7C shows a series of cylindrical light spreading elements 706, FIG. 7D shows a diffraction grating 708 utilized as light spreading elements, and FIG. 7E shows a diffusion surface for use as light spreading elements. It should be noted that the numbers, shapes, arrangement, and sizes of the light spreading elements are not limited to that shown in FIGS. 7A-7E.

Referring to FIG. 7A, the light spreading elements 702 can include hemispherical spheres arranged an array for spreading light. The arrangement of the light spreading elements 702 is not limited to that shown in FIG. 7A. For example in some implementations, the light spreading elements 702 may be randomly arranged, irregularly arranged, arranged in a staggered rows, etc. In some implementations, the light spreading elements 702 can be a spherical cap of any proportion, and not just limited to a hemisphere. In some implementations, the light spreading elements 702 can be aspheric, parabolic or hyperbolic lenses of any proportion. In some implementations, the size of at least one light spreading element 702 can be different from at least one other light spreading element 702. In some implementations, boundaries of at least two adjacent light spreading elements 702 may overlap. In some implementations, the light spreading elements 702 can be about 1 μm to about 15 μm long in at least one dimension.

FIG. 7B shows light spreading elements 704 including prisms arranged in an array. As discussed above in relation to the light spreading elements 702 shown in FIG. 7A, the light spreading elements 704 also can be arranged in irregular, random, staggered, etc., arrangements. In some implementations, the size of at least one light spreading element 704 can be different from the size of another light spreading element 704. In some implementations, boundaries of at least two adjacent light spreading elements 704 may overlap.

FIG. 7C shows light spreading elements 706 including cylindrical elements. In particular, FIG. 7C shows a top view of light spreading elements 706 shaped in longitudinal sections of cylinders. In some implementations, as shown in FIG. 7C, the light spreading elements 706 can be arranged such that the longitudinal axes of the cylindrical sections are substantially parallel to a longer axis of a window, opening, or aperture within which the light spreading elements 706 are disposed. In some implementations, the longitudinal axis of the cylindrical sections may be perpendicular, or any other angle with respect to the longer axis of the window. In some implementations, the light spreading elements 706 can include cylindrical sections arranged at more than two angles with respect to the longer axis of the window. In some implementations, any two adjacent light spreading elements 706 may be spaced apart with their respective boundaries not overlapping.

FIG. 7D shows a diffraction grating that can be utilized as a light spreading element 708. In some implementations, the diffraction grating can include slits spaced apart at a distance that is typically greater than the smallest wavelength of the light emitted from the backlight. In some implementations, the slits in the diffraction grating can be arranged such that the longitudinal axes of the slits are substantially parallel to the longer axis of the window. In some implementations, the light spreading element 708 can include more than one set of diffraction gratings with more than one relative orientation with respect to the longer axis of the window. In some implementations, the diffraction gratings can be formed on the dielectric layer using lasers.

FIG. 7E shows a diffusion surface that can be utilized as a light spreading element 710. In some implementations, the light spreading element 710 can include a roughened surface that can randomly scatter and spread the light towards the front of the display apparatus.

In some implementations, the shapes of the light spreading elements shown in FIGS. 7A-7E also could include aspheric, triangular, hyperbolic, or parabolic shapes. In some implementations, at least two of the height, width, and length of any of the light spreading elements shown above in FIGS. 3-7E can be at least 1 μm.

In some implementations, various light spreading elements in addition to the ones discussed in relation to FIGS. 7A-7E also can be utilized for spreading light. For example, in some implementations, light spreading elements can include volumetric diffusing dielectrics, which may include light spreading particles or substances suspended within the dielectric. The suspended light spreading particles can provide light spreading in addition to the light spreading provided by light spreading treatments over the surface of the dielectric (such as the light spreading diffusion surface 710 discussed above in relation to FIG. 7E).

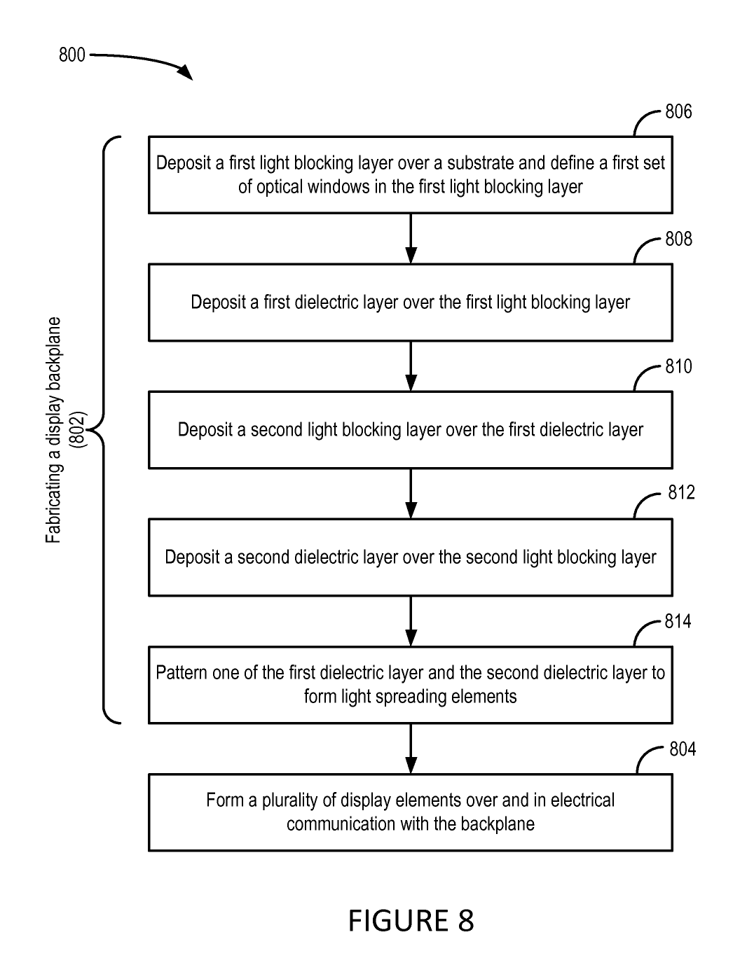

FIG. 8 shows a flow diagram of an example process 800 for forming a display apparatus. In particular, the process 800 includes two phases, fabricating a display backplane (phase 802) and forming a plurality of display elements over and in electrical communication with the backplane (phase 804). The display backplane fabricating phase includes depositing a first light blocking layer over a substrate and defining a first set of optical windows in the first light blocking layer (stage 806); depositing a first dielectric layer over the first light blocking layer (stage 808); depositing a second light blocking layer over the first dielectric layer (stage 810); depositing a second dielectric layer over the second light blocking layer (stage 812); and patterning one of the first dielectric layer and the second dielectric layer to form light spreading elements (stage 814).

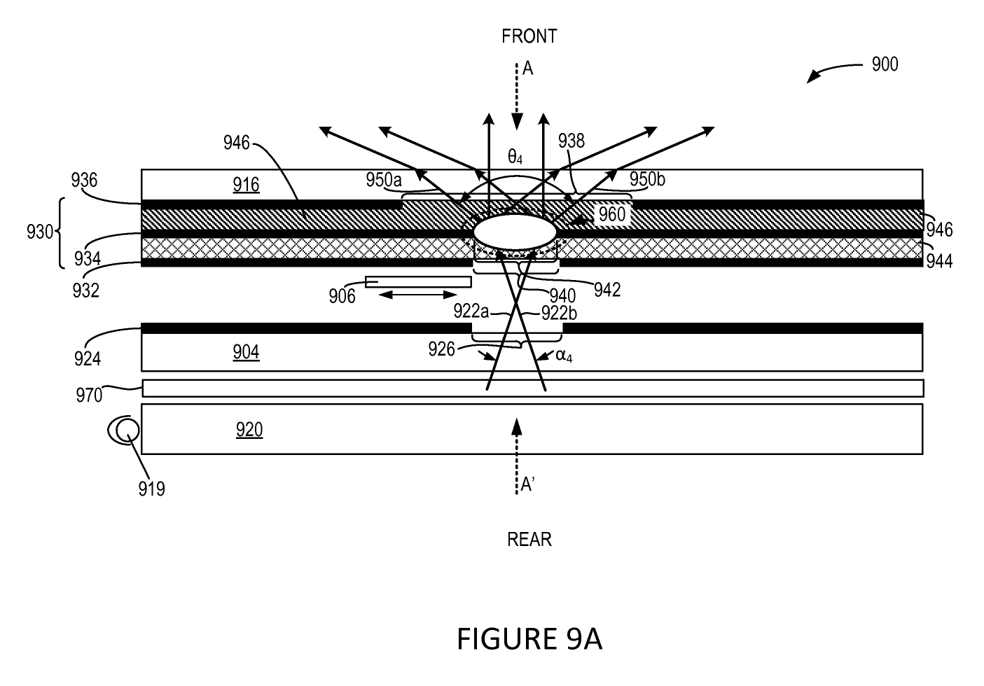

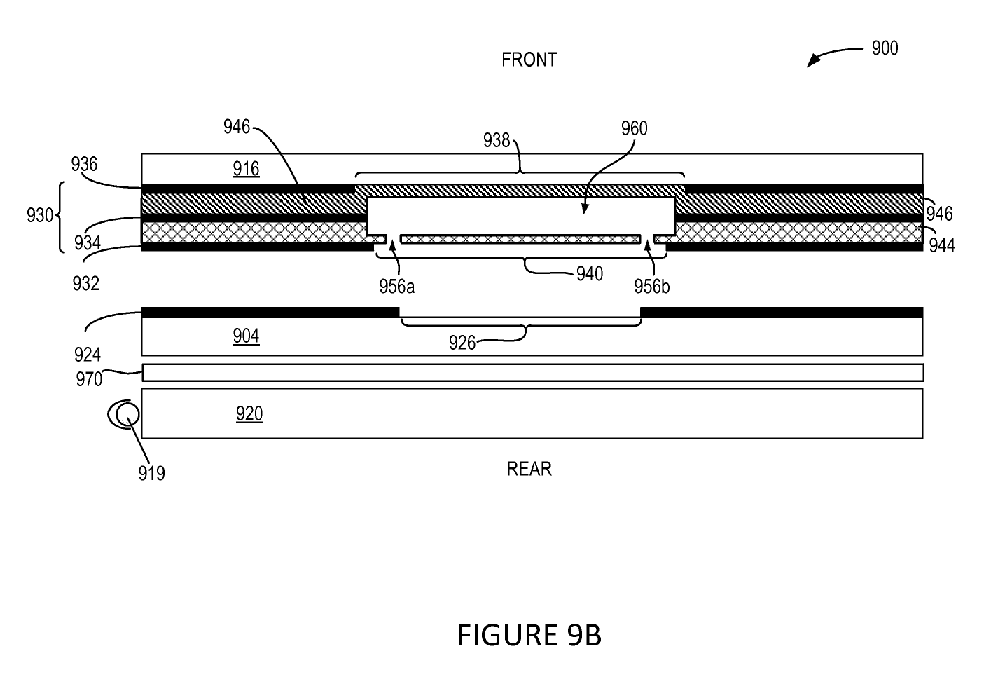

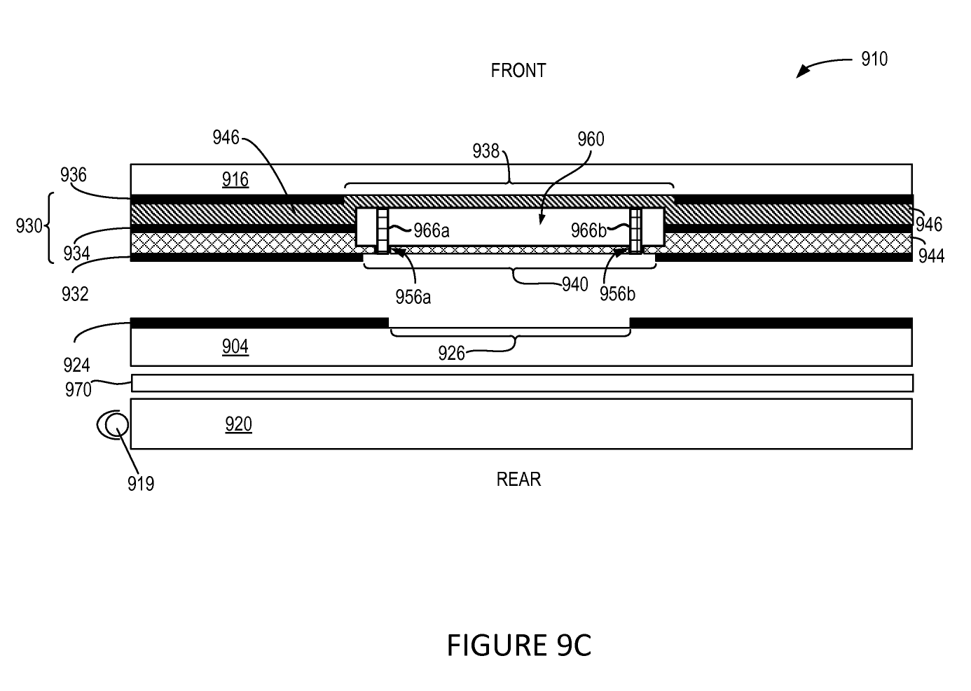

As indicated above, fabricating the display backplane (phase 802) includes depositing a first light blocking layer over a substrate and defining a first set of optical windows in the first light blocking layer (stage 806). In some implementations, the substrate can be formed from glass, plastic or some other substantially transparent material. The first light blocking layer can include light blocking material that can substantially block the passage of light through the light blocking layer. In some implementations, the light blocking material can be a light absorbing material such as carbon-black or titanium-black. In some other implementations, the light blocking material can be a light reflective material such as silver (Ag), aluminum (Al), and copper (Cu) for reflecting light. In some implementation, the light blocking layer can include a combination of light absorbing and light reflecting material. The first light blocking layer can include, for example, the M1 metal layer 336 of the display backplane 330 shown in FIGS. 3 and 4. As another example, the first light blocking layer can include the M1 metal layer 536 shown in FIG. 5, the M1 metal layer 636 shown in FIG. 6, and the M1 metal layer 936 shown in FIGS. 9A-9C. In some implementations, the first light blocking layer can be deposited using a thin-film deposition process, such as DC or RF sputtering, evaporation, or in some cases by chemical or physical vapor deposition. In some implementations, where the light blocking layer includes a light blocking resin, the first light blocking layer can be deposited using spin-on techniques.

The first light blocking layer can be patterned to form openings, apertures, or optical windows to allow light to pass through. For example, the optical window can correspond to the optical window 338 formed in the M1 metal layer 336 shown in FIGS. 3 and 4. As another example, the optical window can correspond to the optical windows 558 and the optical window 668 shown in FIGS. 5 and 6 respectively. In some implementations, a width of the openings can range from about 10 μm to about 25 μm. If the first light blocking layer includes metal, the optical windows can be defined using typical etching techniques, including RF or DC plasma etching, sputter etching, reactive ion milling, and/or wet chemical etching. At the same time the optical windows are etched, various electrical interconnects and components that make up the display backplane can be defined into the first layer of light absorbing material. In some implementations, the first light blocking layer can be patterned primarily to define electrical interconnects and components, and provide negligible optical functionality, such as blocking light. Optical windows in a resin based first light blocking layer may be defined through direct photolithography and development, or through one or more of the etch techniques described above.

The phase of fabricating the backplane (phase 802) further includes depositing a first dielectric layer over the first light blocking layer (stage 808). The first dielectric layer can be formed using materials including, without limitation, silicon dioxide (for example, SiO₂, or in general SiₓO_{y}), silicon nitride (for example Si₃N₄, or in general SiₓN_{y}), silicon oxinitride (SiON, or more generally Si_{X}O_{Y}N_{Z}), aluminum oxide (AlO₃), titanium oxide (TiO₂), hafnium oxide (HfO₂), photodefineable polycarbonate and other polymers, and tantalum pentoxide (Ta₂O₅), which can be deposited either by sputtering, evaporation, slit coating, casting, spin casting, or chemical vapor deposition. In some implementations, first dielectric layer also can be deposited using a spin-on-glass (SOG) technique for depositing materials such as SOG silicates and siloxanes including, without limitation, hydrogen silsesquioxane (HSQ) and methylsilozane. In some implementations, the first dielectric layer may be etched to form windows that are substantially the same size as, and aligned with, the optical windows formed in the first light blocking layer. In some implementations, the first dielectric layer may be etched to form windows that are smaller or larger than the optical windows formed in the first light blocking layer. The first dielectric layer can be patterned using typical etch processes such as RF or DC plasma etching. On example of the first dielectric layer has been discussed above in relation to FIGS. 3 and 4. For example, the first dielectric layer can correspond to the first dielectric layer 346 shown in FIGS. 3 and 4. As another example, the first dielectric layer can correspond to the first dielectric layers 546 and 646 shown in FIGS. 5 and 6, respectively. In some implementations, the first dielectric layer can be planarized during deposition. In some implementations, depositing the first dielectric layer can include depositing two or more dielectric layers having different refractive indices.

The phase of fabricating the backplane also includes depositing a second light blocking layer over the first dielectric layer (stage 810). The second light blocking layer can include materials, and can be deposited in a manner similar to that discussed above in relation to the first light blocking layer. As an example, the second light blocking layer can correspond to the M2 metal layer 334 shown in FIGS. 3 and 4. In some implementations, the second light blocking layer can be patterned, in a manner similar to that discussed above in relation to the first light blocking layer, to have a second set of optical windows that are aligned with the first set of optical windows in the first light blocking layer. As an example, the second set of optical windows can correspond to the optical windows formed in the second light blocking layer 334 shown in FIGS. 3 and 4 that align with the optical window 338 in the first light blocking layer. In some implementations, the second light blocking layer can be patterned to primarily form interconnects connecting various electrical components within the backplane or to form portions of such electrical components (such as transistors and capacitor electrodes), while providing negligible, if any, optical functionality. For example, the second light blocking layer may be patterned such that it is removed from the vicinity of the light spreading elements and from the path of the light passing to and from the light spreading elements.

The phase of fabricating the backplane can further include depositing a second dielectric layer over the second light blocking layer (stage 812). Similar to the first dielectric layer, the second dielectric layer also can be formed using materials including, without limitation, SiO₂, Si₃N₄, AlO₃, TiO₂, HfO₂, photodefineable polycarbonate, and Ta₂O₅, which can be deposited either by sputtering, evaporation, or chemical vapor deposition. In some implementations, the thickness of the second dielectric layer can be greater than the thickness of the first dielectric layer. In some implementations, the thickness of the second dielectric layer can be greater than about 1 μm; for example, between about 1 μm and about 2 μm. In some implementations, the second dielectric layer can be planarized during deposition. For example, the second dielectric layer can correspond to the second dielectric layer 344 shown in FIGS. 3 and 4. In some implementations, depositing the second dielectric layer can include depositing two or more dielectric layers having different refractive indices.

The phase of fabricating the backplane also includes patterning one of the first dielectric layer and the second dielectric layer to form light spreading elements (stage 814). The first dielectric layer or the second dielectric layer can be patterned to form light spreading elements that provide a wide angular light distribution. Examples of the light spreading elements have been discussed above in relation to FIGS. 3-6. Specifically, FIG. 3 shows light spreading elements 360 patterned into the second dielectric layer 344, and FIG. 4 shows light spreading elements 460 patterned into the second dielectric layer 344, FIG. 5 shows light spreading elements 560 patterned into the first dielectric layer 546, and FIG. 6 shows light spreading elements 660 patterned into the second dielectric layer 644a. Other examples of light spreading elements have been discussed above in relation to FIGS. 7A-7E and FIGS. 9A-9C. In some implementations, the light spreading elements can be patterned into the first or the second dielectric layer using anisotropic or isotropic etching techniques. For example, a gray-scale mask can be used in conjunction with an anisotropic etch to form the light spreading elements. In some implementations, one or both the first dielectric layer and the second dielectric layer can be a photodefineable material, such as polycarbonate. In some such implementations, the light spreading elements can be directly photodefined into one of the first dielectric layer and the second dielectric layer using a gray-scale mask. In some implementations, the light spreading elements can be patterned in one of the first and second dielectric layers, with a third dielectric layer forming an etch-stop. An example result of such a technique is discussed above in relation to the light spreading elements 660 shown in FIG. 6.

In some implementations, the phase of fabricating the backplane (phase 802) can include depositing and patterning a third light blocking layer over the second dielectric layer. For example, the third light blocking layer can correspond to the M3 metal layer 324 shown in FIGS. 3 and 4. In some implementations, the third light blocking layer can include light blocking materials, similar to those discussed above in relation to the first and second light blocking layers.

The forming of the display elements (phase 804) can include the formation of a mold over which a shutter assembly is formed, a structural material deposition stage, followed by a patterning stage, and a release stage. To form the mold, a first sacrificial material is deposited and patterned to form vias or openings in which a portion of an anchor can be formed. The openings are formed over contact pads patterned into the layer of the backplane that is closest to the opposing substrate. A second sacrificial material is deposited on top of the patterned first layer of sacrificial material. The second layer of sacrificial material is patterned to form a mold, which includes substantially vertical sidewalls and a top surface. The mold also includes vias or openings that align with the vias and openings formed in the first sacrificial layer. The forming of the display elements further includes deposition and patterning of a structural material that will form the shutter and the anchor. The structural material can include one or more layers of material, such as a metal and/or a semiconductor. The structural material is deposited over the sidewalls and the top surface of the mold, and also in the openings or vias to form electrical connections with the backplane via the contact pads. The deposited structural material is then patterned, typically, using anisotropic etching or a combination of isotropic and anisotropic etching. The patterning is carried out in a manner such that the structural material remains on the sidewalls of the mold to form actuator beams, on the upper surface of the mold to form a shutter, and in the openings of the mold to form the anchor. While the above discusses one example process for forming a display element, a person having ordinary skill in the art will readily understand that a display element could be formed using other fabrication techniques.

FIGS. 9A-9C show cross-sectional views of various additional examples of shutter-based display apparatuses including light spreading elements. In particular, FIGS. 9A and 9B show cross-sectional views of an example shutter-based display apparatus 900 including a light spreading element 960 containing a fluid that can be similar to the fluid surrounding a shutter, while FIG. 9C shows a cross-sectional view of another example shutter-based display apparatus 910 where the light spreading element 960 containing a fluid that can be different from the fluid used for surrounding the shutter. FIG. 9A shows a cross-sectional view of the display apparatus 900 along a short dimension of a second optical window 940 and FIG. 9B shows a cross-sectional view of the display apparatus 900 along a long dimension of the second optical window 940 (for example a cross-section along a plane that is normal to the plane of the page and passes through the lines A and A′ in FIG. 9A).

FIGS. 9A and 9B depict a light spreading element 960 that includes a cavity that can be filled with a fluid. The display apparatus 900 includes many of the components of the display apparatus 500 shown in FIG. 5. For example, the display apparatus 900 includes a shutter 906, suspended between a front substrate 916 and a rear substrate 904. A rear aperture layer 924 formed on the rear substrate 904 defines a rear aperture 926. A backplane 930 is positioned on the rear-facing side of the front substrate 916. The backplane 930 includes three metal layers: an M3 metal layer 932, an M2 metal layer 934, and an M1 metal layer 936. A first dielectric layer 946 separates the M2 metal layer 934 from the M1 metal layer 936, and a second dielectric layer 944 separates the M3 metal layer 932 from the M2 metal layer 934. The M3 metal layer 932, M2 metal layer 934, and M1 metal layer 936 of the backplane 930 define a second optical window 940, a third optical window 942, and a first optical window 938, respectively. The display apparatus 900 also includes a light source 919 and a light guide 920 (together forming a backlight) positioned behind the rear substrate 904. The light guide can be separated from the rear substrate 304 by a BEF 970. The BEF 970 can be similar to the BEF 570 discussed above in relation to the display apparatus 500 shown in FIG. 5, and can aid in directing the light emitted by the backlight towards the front of the display apparatus 900 to reduce the amount of light absorbed within the display apparatus and improve the efficiency and contrast ratio.

Unlike the display apparatus 500 shown in FIG. 5, in which the light spreading element 500 forms an integral part of the first dielectric layer 546, the display apparatus 900 shown in FIGS. 9A and 9B includes the light spreading element 960 including a cavity formed between the first dielectric layer 946 and the second dielectric layer 944. The cavity can be filled with air or another fluid. Light spreading element 960 can spread light incident from the rear of the display apparatus 900. For example, as shown in FIG. 9A, light rays 922a and 922b pass through the second optical window 940 and the second dielectric 944 before being incident on the light spreading element 960 at an angle α₄. The light spreading element 960 spreads the incident light towards the front of the display apparatus 900 as light rays 950a and 950b at a light distribution angle denoted by θ₄, which can be greater than the angle α₄ of the incident light rays 922a and 922b.

As mentioned above, FIG. 9B shows a cross-sectional view of the display apparatus 900 along the long dimension of the second optical window 940. The second dielectric layer 944, which defines a portion of the cavity of the light spreading element 960, includes holes 956a and 956b that extend from the surface of the second dielectric layer 944 that is exposed by the second optical window 940, through the second dielectric layer 944, and into the cavity of the light spreading element 960. The holes 956a and 956b can be of any shape, such as circular, elliptical, rectangular, and squared. The holes can be located anywhere over the surface of the second dielectric layer 944 as long as they access the cavity. In some implementations, as shown in FIG. 9B, the holes 956a and 956b can be located towards the edges of the long dimension of the second optical window 940 so that the holes 956a and 956b affect as little as possible the path of light passing through the second optical window 940 towards the front of the display apparatus 900. In some implementations, the sizes of the holes 956a and 956b can be large enough to allow fluid flow in and out of the cavity of the light spreading element 960 but small enough to have a low impact on the light passing through the second optical window 940 towards the front of the display apparatus 900. In some implementations, the size of the holes 956a and 956b can be about 2 μm to about 10 μm in diameter.

In some implementations, the cavity of the light spreading element 960 can be filled with the fluid utilized by the display apparatus to surround the shutter 906. In some implementations, the shutter 906 can be surrounded by lubricating oil. In some such implementations, the cavity of the light spreading element 960 also is filled with the lubricating oil, which can enter the cavity through the holes 956a and 956b. In some other implementations, if the shutter 906 is surrounded by air, the cavity of the light spreading element 960 also is filled with air.

FIG. 9C shows a cross-sectional view of yet another example shutter-based display apparatus 910 including a light spreading element 960. In particular, FIG. 9C shows the light spreading element 960 having plugs 966a and 966b disposed within the light spreading element 960. The plugs 966a and 966b can plug the holes 956a and 956b, respectively, thereby isolating the cavity from the fluids that are utilized for surrounding the shutter 906. Thus, the light spreading element 960 can include a fluid that is different from the fluid surrounding the shutter 960. In some implementations, the light spreading element 960 can include, for example, air despite the shutter 960 being surrounded by oil.

The shutter-based display apparatuses 900 and 910 discussed above in relation to FIGS. 9A-9C can be formed using process stages similar to those discussed above in relation to FIG. 8. For example, similar to the stages 802 and 804 shown in FIG. 8, forming the shutter-based display apparatus 900 and 910 can include two phases, fabricating a display backplane and forming a plurality of display elements over and in electrical communication with the backplane. Fabricating the display backplane 930 can include depositing the M1 metal layer 936 over the substrate 916 and defining a first optical window 938 in the M1 metal layer 936. The substrate 916 can be formed from glass, plastic, or some other substantially transparent material. The M1 metal layer 936 can be deposited in a manner similar to that discussed in depositing the M1 metal layer 336 shown in FIG. 3, and discussed in relation to FIG. 8 (stage 806). The first optical window 938 can be patterned using process steps similar to those discussed above in forming the first optical window 338 shown in FIG. 3 and discussed in relation to FIG. 8 (stage 806).

The backplane fabrication phase 930 can further include depositing the first dielectric layer 946 over the first light blocking layer 946 and depositing and patterning the M2 metal layer 934. The deposition of the first dielectric layer 946 can be carried out using materials and processes similar to those discussed above in depositing the first dielectric layer 346 shown in FIG. 3, and discussed in relation to FIG. 8 (for example, process stage 808). The deposition and patterning of the M2 metal layer 934 to form the third optical window 942 can be carried out using materials and processes similar to those described in depositing and patterning the M2 metal layer 534 to form the third optical window 542 shown in FIG. 3 and discussed in relation to FIG. 8 (for example, process stage 810). In some implementations, the M2 metal layer 934 can be patterned such that the M2 metal layer does not interfere with the path of light to or from the light spreading element 960.

The backplane fabrication phase 930 can further include patterning the first dielectric layer 946 to form a portion of the light spreading element 960. In some implementations, the patterning of the first dielectric layer 946 can be carried out using techniques such as isotropic etching utilizing the third optical window 942 as an etch mask. In some implementations, a gray-scale mask can be used in conjunction with an anisotropic etch to pattern the first dielectric layer and form a portion of the light spreading element 960. The curvature of the pattern formed within the first dielectric layer 946 can be formed according to the desired shape of the light spreading element 960.

The backplane fabrication phase 930 can further include depositing and patterning a sacrificial material (not shown) over the M2 metal layer 934 and the patterned portions of the first dielectric layer 946 exposed by the third optical window 942. The sacrificial material can be removed from the surface of the M2 metal layer 934 except where the sacrificial material is deposited over the first dielectric layer 946. For example, the sacrificial material can be retained over the first dielectric layer 946 within the opening of the third optical window 942 such that the sacrificial material fills the depression formed in the first dielectric layer 946. In some implementations, a portion of the sacrificial material deposited over the first dielectric layer 946 can be patterned such that the surface of the sacrificial material facing the rear of the display apparatus 900 conforms to a desired shape of the light spreading element 960. In some implementations, the portion of the sacrificial material over the first dialectic layer 946 can include a convex protrusion extending towards the rear of the display apparatus 900 and beyond the plane of the M2 metal layer 934. In some implementations, the sacrificial material can be patterned such that the sacrificial material has an elliptical cross-section, similar to the desired cross-section of the light spreading element 960 shown in FIG. 9A. The sacrificial material can be patterned using a combination of isotropic and anisotropic etching techniques. In some implementations, the sacrificial material can be photodefineable, and can be directly patterned using a gray-scale photo mask.

The backplane fabrication phase 930 can further include depositing a second dielectric layer 944 over the M2 metal layer 934 and over the patterned sacrificial material. The deposition of the second dielectric layer 944 can use materials and processes similar to those discussed above for depositing the second dielectric layer 344 shown in FIG. 3 and discussed in relation to FIG. 8. The second dielectric layer 944 can be deposited such that it completely covers the sacrificial material. The second dielectric layer 944 can be patterned to form the holes 956a and 956b (shown in FIG. 9B) such that the underlying sacrificial material is exposed. In some implementations, the holes 956a and 956b can be formed towards the edges of the long dimension of the third optical window 942. While only two holes 956a and 956b are shown in FIG. 9B, the second dielectric layer 944 can be patterned to form only one or more than two holes.

In some implementations, the backplane fabrication phase 930 can further include deposition and patterning of the M3 metal layer 932. The M3 metal layer 932 can be a metal layer similar to the M1 and M2 metal layers 936 and 934. The M3 metal layer 932 can be patterned to form the second optical window 940 to expose the portion of the second dielectric layer 944 that covers the sacrificial material.

The backplane fabrication phase 930 can further include removing the sacrificial material. In some implementations, the sacrificial material can be removed using an etchant that makes contact with the sacrificial material through the holes 956a and 956b, and etches only the sacrificial material. In some implementations, the sacrificial material can include a photoresist material. In some such implementations, the process of removing the sacrificial material can include utilizing plasma ashing to etch the photoresist containing sacrificial material. Removal of the sacrificial material results in a cavity, of the light spreading element 960, between the first dielectric layer 946 and the second dielectric layer 944, as shown in FIGS. 9A and 9B.

In some implementations, the backplane fabrication phase 903 can further include plugging the holes 956a and 956b in the second dielectric layer 944 as shown in FIG. 9C. In some implementations, a directional or anisotropic deposition technique, such as physical vapor deposition techniques like molecular and ion beam deposition, can be utilized to deposit a column of material through each of the two holes 956a and 956b without filling the entire cavity. The material can be deposited until the holes 956a and 956b are completely plugged to form plugs 966a and 966b, as shown in FIG. 9C, and the remaining material can then be removed via patterning techniques. The plugs 966a and 966b can isolate the cavity of the light spreading element 960 from the fluids utilized for surrounding the shutter 906 (shown in FIG. 9A). The deposition of the dielectric can be stopped once the holes 956a and 956b are plugged. Thereafter, the dielectric deposited on the remainder of the second dielectric layer 944 can be removed using etching or a photomask. In some implementations, the M3 metal layer 932 can be deposited and patterned following the plugging of the holes 956a and 956b with plugs 966a and 966b, respectively. In some such implementations, the M3 metal layer 932 can be patterned to form the second optical window 940 such that the M3 metal layer 932 covers the plugs 966a and 966b.

In some implementations the holes 956a and 956b can be plugged by dispensing micro-droplets of epoxy. In some other implementations the holes 956a and 956b can be plugged with successive conformal coatings, where the successive conformal coatings close the holes without completely filling the cavity. In yet some other implementations the holes 956a and 956b can be capped by spin-coating over the second dielectric layer 944 with a viscous enough curable material, or material with high enough surface tension, such that it does not fill the cavity before curing.

The formation of the display elements over the backplane can be carried out in a manner similar to that discussed in relation to phase 802 shown in FIG. 8. In some implementations, after the formation of the display elements, such as the shutter 906, the display elements can be surrounded by a fluid such as oil. With the display apparatus 900 shown in FIG. 9A, where the holes 956a and 956b are unplugged, the fluid utilized for surrounding the display elements also fills the cavity of the light spreading element 960. On the other hand, if the holes 956a and 956b are plugged, for example, such as shown in FIG. 9C, the fluid utilized for surrounding the display elements does not enter the cavity of the light spreading element 960.

In some implementations, the first optical windows 338 in display apparatuses 300 and 400 shown in FIGS. 3 and 4, respectively; the first optical windows 538 in display apparatus 500 shown in FIG. 5; the first optical window 638 in display apparatus 600 shown in FIG. 6; and the first optical windows 938 in display apparatus 900 and 910 shown in FIGS. 9A-9C, can be defined by a doped spin-on-glass material instead of being defined by the respective M1 metal layer (such as the M1 metal layer 336, 536, 636, or 936). The doped SOG material can be a light blocking material, such as a carbon-doped SOG material. In some implementations, the M1 metal layer in one or more of the above mentioned display apparatuses can be replaced with a doped SOG material. In some other implementations, the M1 metal layer in one or more of the above mentioned display apparatuses can be deposited over the doped SOG material, which is in turn deposited over the substrate facing the front of the display apparatus (such as the substrate 316, 516, 616, and 916). In some such implementations, the first optical windows can be defined by the doped SOG material, while an additional set of optical windows, aligned with the first optical windows can be defined by the M1 metal layer.

In some implementations, the M2 metal layer 934 can be patterned to primarily form interconnects connecting various electrical components within the backplane 930 and to provide negligible optical functionality. For example, the M2 metal layer 934 can be patterned such that the M2 metal layer 934 is removed from the vicinity of the light spreading elements 960 and from the path of the light passing to and from the light spreading elements 960.

As described above with respect to FIGS. 3-9C, display apparatuses can include one or more light blocking layers disposed between dielectric layers or between dielectric layers and a substrate. In FIGS. 3-9C, such light blocking layers are described primarily as being formed from metals, for example, metals forming one or more of the M1, M2, and M3 metal layers shown in FIGS. 3-6 and 9A-9C. Many of such metals are reflective in nature. In some implementations one or more of the light blocking layers can include a stack of layers of multiple materials such that the front and/or the rear reflectivity of the one or more light blocking layers is low. For example, in some implementations, the stack of layers can include a highly conductive (but reflective) layer, such as aluminum, cladded above and/or below with a darker metal (or metal alloy) layer like titanium or molybdenum. In some other implementations, the stack of layers can include a highly conductive (but reflective) layer, such as aluminum, cladded above and/or below with a combination of thin metal and dielectric layers configured to produce interferometric absorption. In other implementations one or more of the light blocking layers may include a doped SOG material.

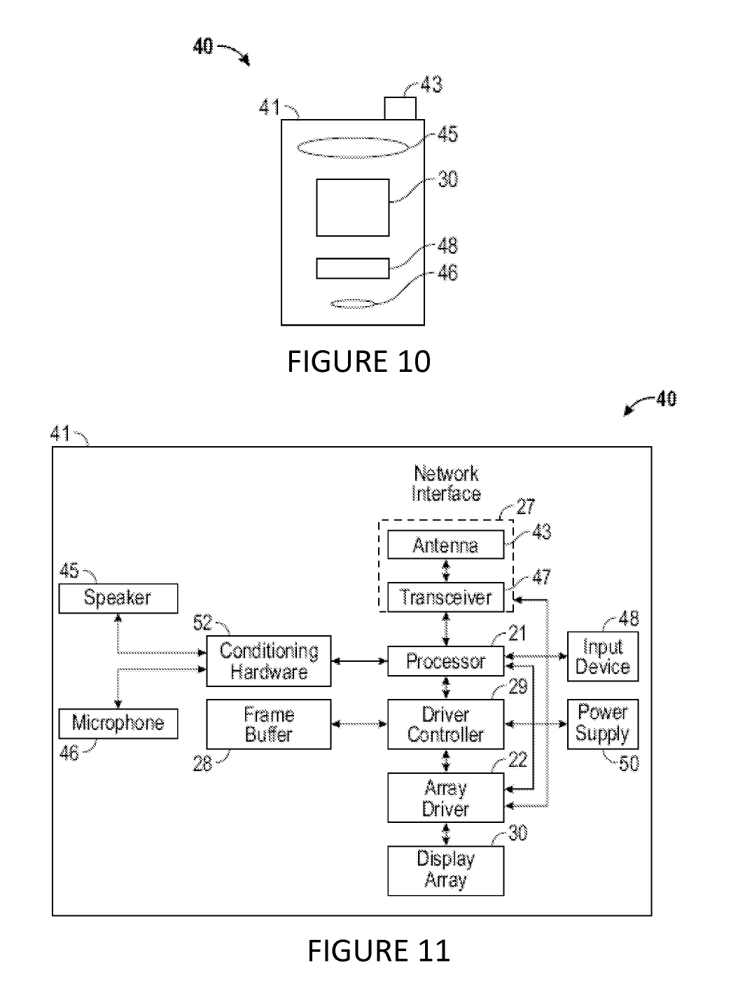

FIGS. 10 and 11 show system block diagrams of an example display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be capable of including a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein.

The components of the display device 40 are schematically illustrated in FIG. 11. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 10, can be capable of functioning as a memory device and be capable of communicating with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to any of the IEEE 16.11 standards, or any of the IEEE 802.11 standards. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G, or further implementations thereof, technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29 is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22 and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as a mechanical light modulator display element controller). Additionally, the array driver 22 can be a conventional driver or a bi-stable display driver (such as a mechanical light modulator display element controller). Moreover, the display array 30 can be a conventional display array or a bi-stable display array (such as a display including an array of mechanical light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40. Additionally, in some implementations, voice commands can be used for controlling display parameters and settings.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus, comprising:
a substrate;
a first light blocking layer oriented parallel to the substrate and defining a first set of optical windows;
a first dielectric layer positioned over the first light blocking layer;
a second light blocking layer positioned over the first dielectric layer;
a second dielectric layer positioned over the second light blocking layer;
light spreading elements disposed in at least one of the first dielectric layer and the second dielectric layer, wherein the light spreading elements are aligned with the first set of optical windows; and
a light modulator positioned adjacent the light spreading elements.

2. The apparatus of claim 1, further including a collimated backlight capable of emitting collimated light towards the light spreading elements.

3. The apparatus of claim 1, wherein the second light blocking layer defines a second set of optical windows substantially aligned with the first set of optical windows.

4. The apparatus of claim 1, wherein a longitudinal axis of the light spreading elements is substantially parallel to a long axis of an optical window defined in the first light blocking layer.

5. The apparatus of claim 1, wherein the first light blocking layer and the second light blocking layer each include a metal.

6. The apparatus of claim 1, wherein one of the first dielectric layer and the second dielectric layer includes photodefineable polycarbonate.

7. The apparatus of claim 1, wherein the apparatus further includes a third light blocking layer positioned over the second dielectric layer and defining a third set of optical windows substantially aligned with the first set of optical windows.

8. The apparatus of claim 1, wherein the apparatus further includes a third dielectric layer positioned adjacent to one of the first dielectric layer and the second dielectric layer, a boundary of which forms at least a portion of a boundary of the light spreading elements.

9. The apparatus of claim 3, wherein the apparatus further includes an output optical window defined in a light blocking layer, the output optical window being a narrowest optical window of all optical windows defined in the light blocking layers of the apparatus, and wherein the light spreading elements are formed in a dielectric layer positioned in front of the output optical window with respect to the backlight.

10. The apparatus of claim 1, wherein one of the first dielectric layer and the second dielectric layer in which the light spreading elements are disposed has a thickness of at least 1 μm.

11. The apparatus of claim 1, wherein at least two of a length, width and height of the light spreading elements is at least 1 μm.

12. The apparatus of claim 1, wherein the light spreading elements include a fluid substantially enclosed by the first dielectric layer and the second dielectric layer.

13. The apparatus of claim 12, wherein the fluid is the same as a fluid used for surrounding the light modulator.

14. The apparatus of claim 12, wherein the fluid is different from a fluid used for surrounding the light modulator.

15. The apparatus of claim 1, wherein the apparatus includes a backplane including the first light blocking layer, the first dielectric layer, the second light blocking layer, the second dielectric layer, and the light spreading elements, and wherein the light modulator is in electrical communication with the backplane.

16. The apparatus of claim 1, further comprising:
a display;
a processor capable of communicating with the display, the processor being capable of processing image data;
a memory device capable of communicating with the processor;
a driver circuit capable of sending at least one signal to the display, wherein the processor is further capable of sending at least a portion of the image data to the driver circuit;
an image source module capable of sending the image data to the processor, wherein the image source module includes at least one of a receiver, transceiver, and transmitter; and
an input device capable of receiving input data and to communicate the input data to the processor.

17. A method of manufacturing a display apparatus, comprising:
depositing a first light blocking layer over a substrate and defining a first set of optical windows in the first light blocking layer;
depositing a first dielectric layer over the first light blocking layer;
depositing a second light blocking layer over the first dielectric layer;
depositing a second dielectric layer over the second light blocking layer;
patterning one of the first dielectric layer and the second dielectric layer to form light spreading elements; and
forming a plurality of display elements positioned adjacent the light spreading elements.

18. The method of claim 17, further comprising patterning the second light blocking layer to define a second set of optical windows substantially aligned with the first set of optical windows.

19. The method of claim 17, wherein the plurality of display elements includes a plurality of light modulators positioned to modulate light emitted from a backlight and directed to the light spreading elements.

20. The method of claim 17, wherein patterning one of the first dielectric layer and the second dielectric layer to form light spreading elements includes aligning a longitudinal axis of the light spreading elements substantially parallel to a long axis of the first set of optical windows.

21. The method of claim 17, wherein patterning one of the first dielectric layers and the second dielectric layer to form light spreading elements includes forming the light spreading elements with at least two of the height, length, and width of the light spreading elements being at least 1 μm.

22. The method of claim 17, wherein forming a plurality of display elements positioned adjacent the light spreading elements includes forming the plurality of display elements in electrical communication with at least one of the first light blocking layer and the second light blocking layer.

23. The method of claim 17, further including:
patterning the first dielectric layer exposed to form a depression;
depositing a third dielectric layer over the patterned first dielectric layer; and
depositing the second dielectric layer over the third dielectric layer;
wherein patterning one of the first dielectric layer and the second dielectric layer to form the light spreading element includes patterning the second dielectric layer to define holes in the second dielectric layer and removing the third dielectric layer through the holes.

24. The method of claim 23, further including depositing a fourth dielectric layer to plug the holes defined in the second dielectric layer.

25. The method of claim 17, further including depositing a third light blocking layer over the second dielectric layer and defining a set of output optical windows in the third light blocking layer substantially aligned with the light spreading elements and wherein the set of output optical windows are narrower than the first set of optical windows.

26. The method of claim 17, wherein depositing a second dielectric layer over the second light blocking layer includes planarizing the second dielectric layer with a thickness of at least 1 μm.

27. An apparatus, comprising:
a substrate;
a first light-blocking layer oriented parallel to the substrate and defining a first set of optical windows;
a first dielectric layer positioned over the first light blocking layer;
a second light blocking layer positioned over the first dielectric layer;
a second dielectric layer positioned over the second light blocking layer;
light spreading means for spreading light incident from a rear side of the apparatus towards a front side of the apparatus, the light spreading means disposed in at least one of the first dielectric layer and the second dielectric layer wherein the light spreading means are aligned with the first set of optical windows; and
a light modulator positioned adjacent the light spreading means.

28. The apparatus of claim 27, wherein the second light blocking layer defines a second set of optical windows substantially aligned with the first set of optical windows.

29. The apparatus of claim 27, further including a collimated backlight capable of emitting collimated light towards the light spreading means.

30. The apparatus of claim 27, wherein a longitudinal axis of the light spreading means is substantially parallel to a long axis of an optical window defined in one of the first dielectric layer and the second dielectric layer in which the light spreading means are disposed.
